(19) United States
(12) Patent Application Publication
(10) Pub. No.: US 2023/0306073 A1
(43) Pub. Date: Sep. 28, 2023

(54) WEBSITE CREATION SYSTEM AND METHOD

(71) Applicant: Etison, LLC dba ClickFunnels, Eagle, ID (US)

(72) Inventors: Todd Dickerson, Cranton, GA (US); Russell Brunson, Eagle, ID (US)

(21) Appl. No.: 18/204,464

(22) Filed: Jun. 1, 2023

Related U.S. Application Data
(63) Continuation-in-part of application No. 17/304,159, filed on Jun. 15, 2021.
Application No. 17/304,159 is a continuation of application No. 15/880,255, filed on Jan. 25, 2018, now Pat. No. 11,068,559.

(51) Int. Cl. G06F 16/958; G06F 3/0481; G06F 16/951; G06F 40/186

(52) U.S. Cl. CPC G06F 16/972; G06F 3/0481; G06F 16/951; G06F 40/186

(57) ABSTRACT

In a method for creating a website, a user, a systems administrator, for example, receives a series of directional webpages configured to cause an end user interaction with a website. The directional webpages may be a tree of webpages configured to be provided and displayed to an end user of the website. The user may define a conditional split in the tree of webpages, in which one of at least two branches is to be provided to the end user upon satisfaction of a predetermined condition associated with the conditional split. The system automatically analyzes end user interactions with the website or data associated with the end user to determine whether the predetermined condition has been satisfied by the end user, and based upon the analysis, provides the appropriate webpage to the end user.

### REFERENCE TO RELATED APPLICATIONS

This application is a continuation-in-part of, and claims priority to, U.S. application Ser. No. 17/304,159, titled “Website Creation System for Creating Websites having at least One Series of Directional Webpages and Related Methods,” filed Jun. 15, 2021, which is a continuation of U.S. Ser. No. 15/880,255, filed Jan. 25, 2018 and issued as U.S. Pat. No. 11,068,559, titled “Website Creation System for Creating Websites having at least One Series of Directional Webpages and Related Methods.” The related patent and patent application are incorporated herein by reference.

### BACKGROUND AND SUMMARY

The Internet has played an influential role in developing electronic commerce. Furthermore, one who may want to create a website for selling a product and/or service in hopes of yielding favorable results (e.g., sales, opt-ins, etc.) must often hire two or more different companies to develop and generate different portions of the website. This results in extreme, and in some cases, hindering costs before ever selling a product and/or service. Moreover, the website owner typically has very little ability to personally edit and adjust the website to meet the adjusting needs of website guests (e.g., customers) without again turning to the development companies and paying additional fees for their services. Other options for creating a website include employing “cookie cutter” (e.g., one type fits all) websites that all look substantially the same and are not tailored to the website owners' products and/or services. Thus, because the resultant websites are not created under one roof and/or are not tailored to products and/or services offered thereon, the resultant websites are often clunky, not user friendly, and overall unappealing and unpersuasive to potential customers. This conventionally results large numbers of in abandoned carts, lost sales, and overall poor results for the website owner. Accordingly, these and other disadvantages exist with respect to conventional methods and systems for creating websites.

A website creation system and method according to the present disclosure improves upon past systems by providing a method for a system administrator to create directional sites, or funnels, in which conditional splits in a “tree” of webpages may be defined to provide a preferred website to an end user. In one embodiment of the method for creating a website, a user, a systems administrator, for example, receives a series of directional webpages configured to cause an end user interaction with a website. The directional webpages may be a tree of webpages configured to be provided and displayed to an end user of the website. The user may define a conditional split in the tree of webpages, in which one of at least two branches is to be provided to the end user upon satisfaction of a predetermined condition associated with the conditional split. The system automatically analyzes end user interactions with the website or data associated with the end user to determine whether the predetermined condition has been satisfied by the end user, and based upon the analysis, provides the appropriate webpage to the end user.

### BRIEF DESCRIPTION OF THE DRAWINGS

FIG. 1 illustrates a schematic representation of an environment within which a website creation and operation system can operate in accordance with one or more embodiments of the present disclosure.

FIGS. 2A and 2B illustrate a sequence flow diagram that a website creation and operation system can utilize to create and operate a website in accordance with one or more embodiments.

FIG. 3 illustrates a sequence flow diagram depicting a method of determining and providing a branch of a tree of webpages to a user, in accordance with one or more embodiments of the present disclosure.

FIG. 4 illustrates an example tree of webpages including conditional splits and branches to be provided to an end user, in accordance with one or more embodiments of the present disclosure.

FIG. 5A is an exemplary GUI of a directional site or funnel being created.

FIG. 5B is an exemplary GUI illustrating the beginning of a funnel for a split path option.

FIG. 5C is an exemplary GUI illustrating the options for building a funnel with a conditional path.

FIG. 5D is an exemplary GUI illustrating the creation of an exemplary single-conditional funnel under construction.

FIG. 5E is an exemplary GUI illustrating how a user defines a conditional split path, which will be displayed in the condition block after creation.

FIG. 5F illustrates an exemplary funnel that a user has set up using the GUIs of FIGS. 5A-5E.

FIG. 5G is an exemplary GUI illustrating how a user defines a funnel with a dual split path.

FIG. 5H is an exemplary GUI illustrating a funnel with a three-way split path.

FIG. 5I is an exemplary GUI illustrating how a user may set up a custom traffic ratio.

FIG. 5J is an exemplary GUI further illustrating how a user selects a custom traffic ratio.

FIG. 5K is an exemplary GUI that a user uses to select a path of a multi-conditional path.

FIG. 5L depicts a GUI for defining Path A of a multi-conditional path.

FIG. 5M depicts an exemplary funnel with a multiple split path showing graphically the web pages that will be displayed for each step in each path.

FIG. 6A depicts an exemplary GUI showing funnels that have been created by a user, that may be selected for viewing or editing.

FIG. 6B depicts an exemplary GUI for users illustrating the process to create funnels.

FIG. 6C depicts an exemplary GUI 610 showing the exemplary users who are allowed access to view and edit funnels.

FIG. 6D depicts a settings GUI according to an exemplary embodiment of the present disclosure.

FIG. 6E depicts a second settings GUI according to an exemplary embodiment of the present disclosure.

FIG. 7A depicts an exemplary GUI for enabling a system administrator to display metrics related to webpages of the website, in accordance with one or more embodiments of the present disclosure.

FIG. 7B depicts a second exemplary GUI for enabling a system administrator to display metrics related to webpages of the website, in accordance with one or more embodiments of the present disclosure.

FIGS. 8A-8G illustrate a plurality of schematic representations of graphical user interfaces of the website creation and operation system for enabling a system administrator to create and edit workflows in accordance with one or more embodiments of the present disclosure.

FIG. 9 illustrates a block diagram of an example computing device in accordance with one or more embodiments of the present disclosure.

FIG. 10 depicts a Calendar Events GUI according to an exemplary embodiment of the present disclosure

### DETAILED DESCRIPTION

The illustrations presented herein are not actual views of any particular website creation system, or any component thereof, but are merely idealized representations which are employed to describe the present invention.

As used herein, the singular forms following “a,” “an,” and “the” are intended to include the plural forms as well, unless the context clearly indicates otherwise.

As used herein, the term “may” with respect to a material, structure, feature, function, or method act indicates that such is contemplated for use in implementation of an embodiment of the disclosure, and such term is used in preference to the more restrictive term “is” so as to avoid any implication that other compatible materials, structures, features, functions, and methods usable in combination therewith should or must be excluded.

As used herein, any relational term, such as “first,” “second,” etc., is used for clarity and convenience in understanding the disclosure and accompanying drawings and does not connote or depend on any specific preference or order, except where the context clearly indicates otherwise.

As used herein, the term “substantially” in reference to a given parameter, property, act, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

The illustrations presented herein are not actual views of any particular website creation system, or any component thereof, but are merely idealized representations, which are employed to describe the present invention.

One or more embodiments of the present disclosure include a website creation system for enabling a user (e.g., a system administrator) to create a website. Furthermore, the website creation system may enable the user to create a web site having a series of directional webpages. The series of directional webpages may include a series (e.g., a sequence or funnel) of webpages that are ordered and designed to entice (e.g., elicit, encourage, prompt, evoke, cause, etc.) at least one particular user interaction with the website. For instance, the series of directional webpages may funnel (e.g., direct, aim, etc.) a guest of the website toward a particular user interaction. In one or more embodiments, the series of directional webpages may include a plurality of branches of webpages (e.g., a tree of webpages) provided in a dynamic sequence upon satisfaction of predetermined conditions during a single web browsing session. In additional embodiments, the series of directional webpages may include a plurality of branches of webpages provided in a dynamic sequence upon satisfaction of predetermined conditions during multiple different web browsing sessions. In some embodiments, the series of directional webpages may be designed and intended to cause a guest of the created website to remain on the website, opt into an email list, provide contact information (e.g., an email address, a telephone number, a social media identifier, etc.), share a portion of the website on social media, complete a purchase, complete multiple purchases, add an item to a cart, visit another website, interact with a chat messenger, view a video on the website, view an image on the website, etc.

Because the website creation system of the present disclosure enables a user to create, within a single system, a website that includes at least one series of directional webpages ordered and designed to entice particular user interaction, the website creation system is advantageous over conventional website creation systems. For instance, because the website creation system enables a user to create a website while working with a single system instead of multiple developers and systems, the website creation system reduces required processing power, memory, and communication resources needed to facilitate creating websites. Accordingly, the website creation system results in less data transfer and data bandwidth usage for a computer/communication system. In other words, the website creation system results in less required processing power and communication bandwidth in comparison to conventional systems. As a result, the website creation system of the present disclosure, in comparison to conventional systems, may be a more appropriate system for mobile devices. Additionally, in view of the foregoing, the website creation system may result in more user friendly, consistent, attractive, and persuasive websites in comparison to conventional website creation systems and methods.

Moreover, some embodiments of the present disclosure include a website creation system for enabling a user (e.g., a system administrator) to monitor and edit a website to meet the needs of current traffic (e.g., guests) visiting the website. For instance, the website creation system includes a website editor graphical user interface (“GUI”) for display to the system administrator on a client device. The website editor GUI may include a selectable element (e.g., tab) representing each webpage of the website (e.g., each webpage of the series of directional webpages of the website). Furthermore, the website editor GUI may enable the system administrator to add media objects (e.g., images, videos, audio files, hyperlinks, surveys, text) to the website. Moreover, the website editor GUI may enable a system administrator to add interfaces with social media networks and to add payment processors to the website. Additionally, the website editor GUI may enable the system administrator to add dynamic conditional splits to the website, which cause the end user to receive a personalized, unique, and dynamic experience while visiting the website.

Additional embodiments of the present disclosure include a website creation and operation system for enabling a user (e.g., a system administrator) to create one or more conditional splits related to the user's created website. For instance, the user can customize the website to provide particular webpages in response to an end user (e.g., guests or visitors of the website) satisfying one or more predetermined conditions correlating with one of more actions and/or attributes of the end user. As a non-limiting example, upon satisfaction of a predetermined condition during an end user's interaction with the website, a particular branch of a tree of webpages may be provided to the end user. As a non-limiting example, if an end user individual is within a particular age range and clicks on a particular link of a webpage, the website creation and operation system may provide a different webpage for that end user individual than the website creation and operation system would provide for a person of a different age range. This determination of which webpage to provide to an end user may be performed automatically and in real time following the creation of a conditional split by a system administrator of the website creation and operation system. Furthermore, the satisfaction of predetermined conditions causes the website to provide particular webpages in specific technological ways.

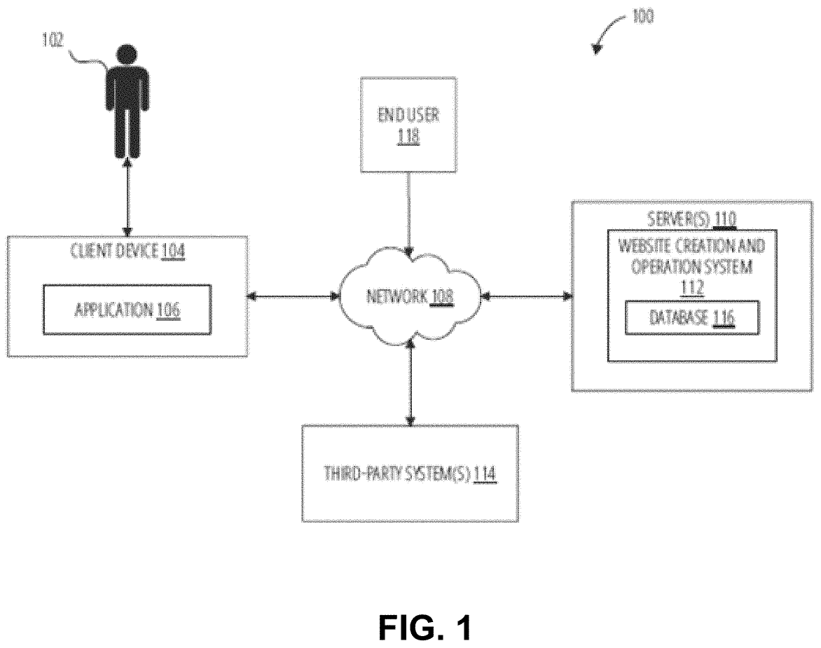

FIG. 1 illustrates a schematic diagram of an environment 100 in which a website creation and operation system 112 can operate according to one or more embodiments of the present disclosure. As illustrated, the environment 100 includes a client device 104, at least one server(s) 110 including a website creation and operation system 112, a network 108, an end user 118, and one or more third-party system(s) 114. The website creation and operation system 112, the client device 104, the end user 118, and the third-party system(s) 114 can communicate via the network 108. The network 108 may include one or more networks, such as the Internet, and can use one or more communications platforms or technologies suitable for transmitting data and/or communication signals. Although FIG. 1 illustrates a particular arrangement of the client device 104, the server(s) 110, the third-party system(s) 114, and the network 108, various additional arrangements are possible. For example, the server(s) 110 and, accordingly, the web site creation and operation system 112, can directly communicate with the client device 104, bypassing the network 108. As another example, the end user 118 may communicate with client device 104 directly, bypassing the network 108.

As illustrated in FIG. 1, a user 102 can interface with the client device 104, for example, to communicate with the server(s) 110 and to utilize the website creation and operation system 112 to create a website. The user 102 can be an individual (i.e., human user), a business, a group, or any other entity. Although FIG. 1 illustrates only one user 102 associated with the client device 104, the environment 100 can include any number of a plurality of users that each interact with the environment 100 using a corresponding client device.

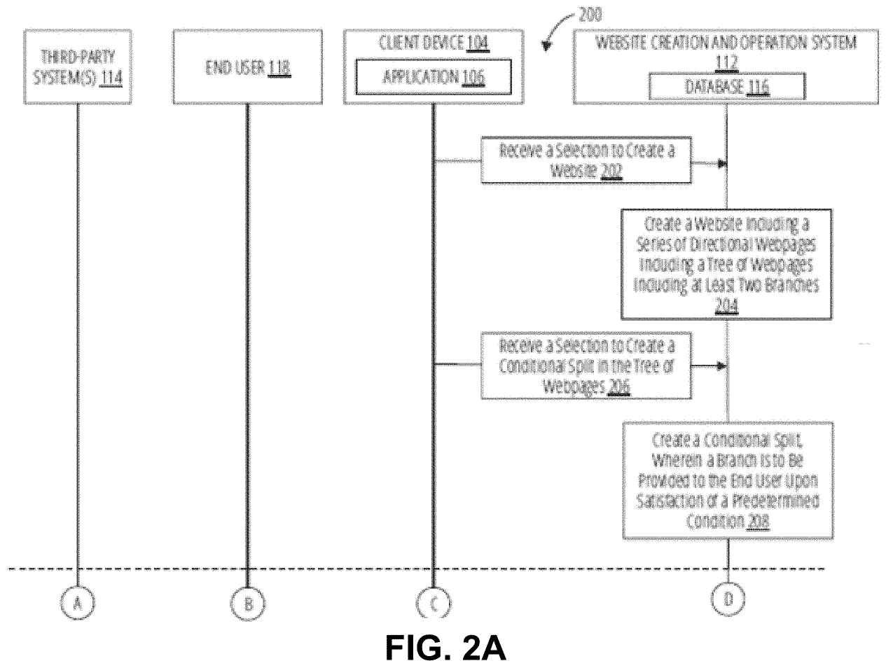

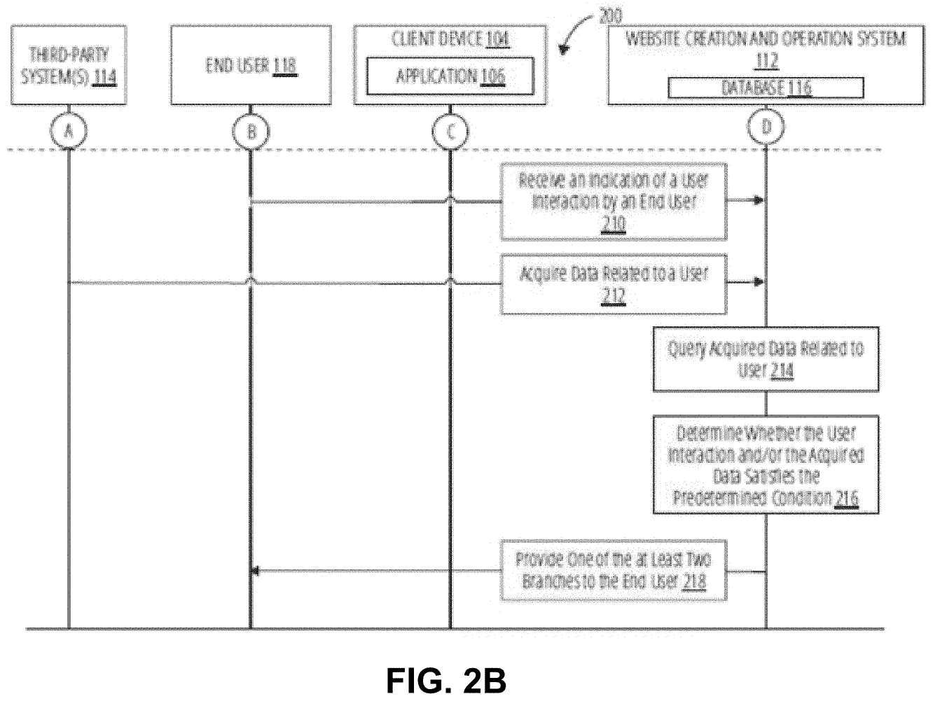

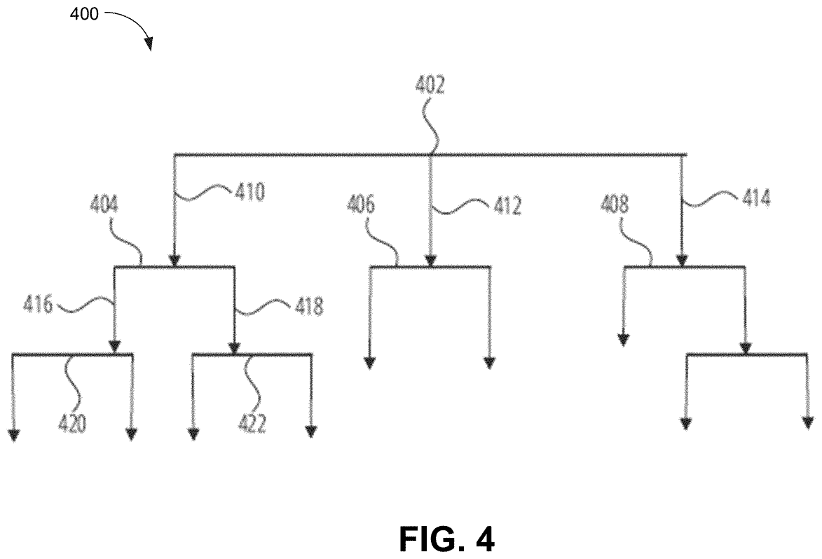

In some embodiments, the web site creation and operation system 112 can include a system associated with an entity such as a website creation provider, which provides tools and editor graphical user interfaces to user(s) 102 to create websites. For example, the website creation and operation system 112 may enable a user (also referred to herein as “system administrator”) to create a website that includes a series of directional webpages designed and sequenced (e.g., arranged in a particular order) to elicit (e.g., entice) a particular user interaction with the website (e.g., provide contact information, opt in to receive communications from the website, complete a purchase, complete multiple purchases, add something to a cart, interact with (e.g., click) a selectable element (e.g., a button) of the website, share the website and/or a purchase on a social media network). The sequence and/or order of the presentation of the webpages is dynamic and may change based on the satisfaction of predetermined conditions by an end user 118. Additionally, the website creation and operation system 112 may enable a system administrator to monitor activity on a website created via the website creation and operation system 112 and/or edit a website created via the website creation and operation system 112. The website creation and operation system 112 may allow for end users (e.g., end users 118) to interact with the website, which may provide webpages to the end user 118 in a dynamic manner. The webpages provided to the end user 118 may be different from the webpages provided to another different end user. The series of directional webpages is described in further detail below with respect to FIGS. 2A-2B and FIG. 4.

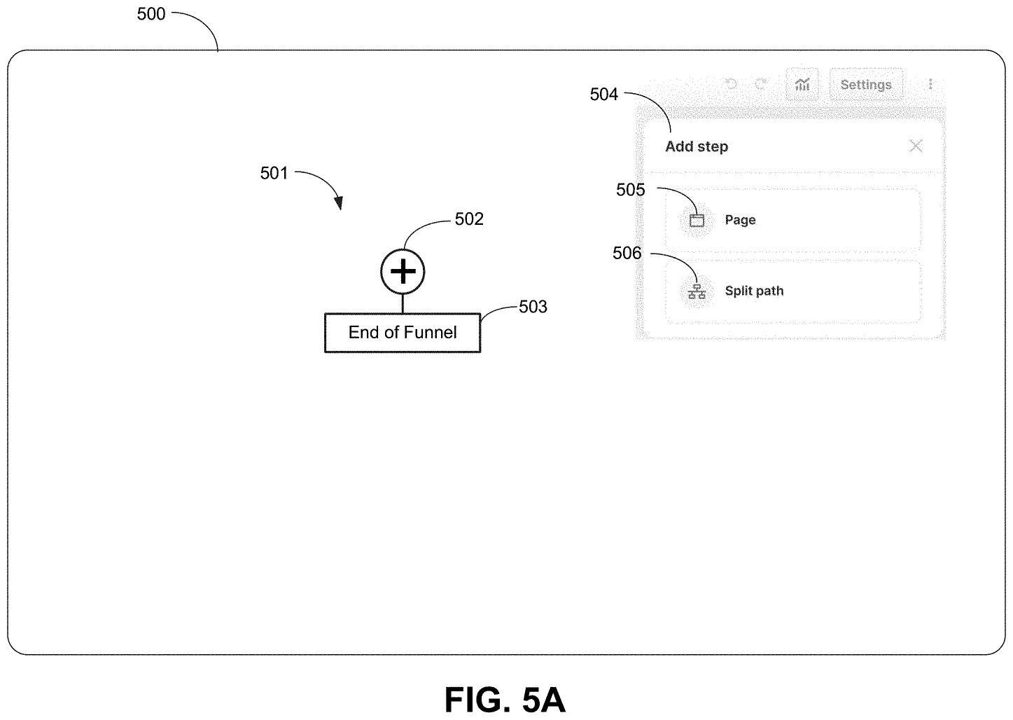

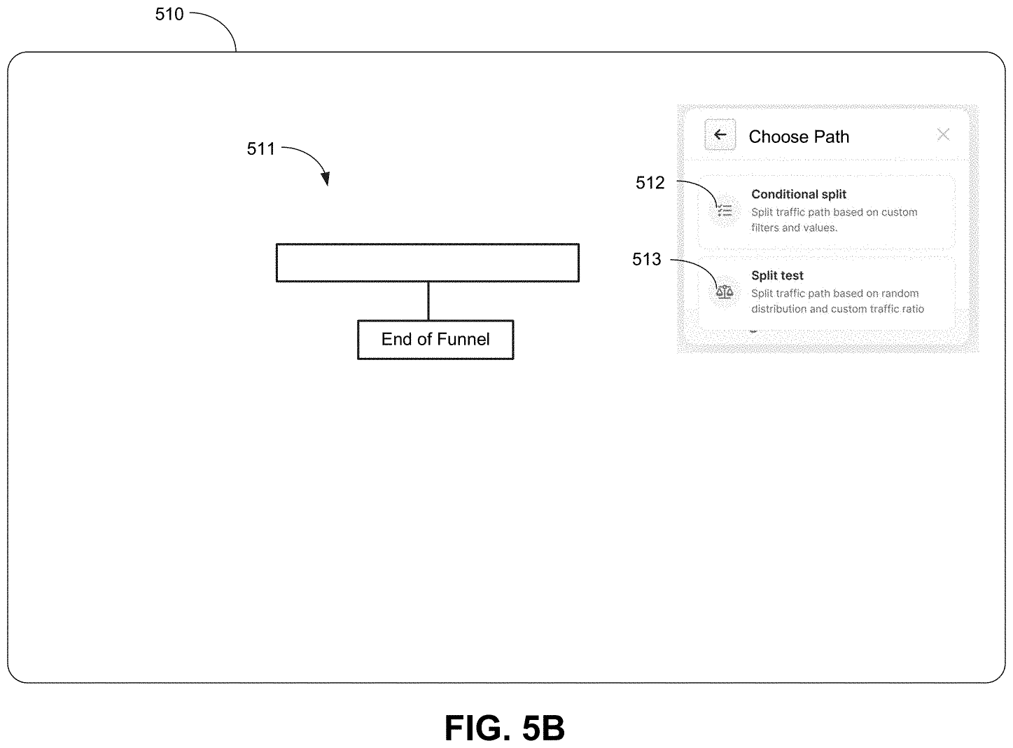

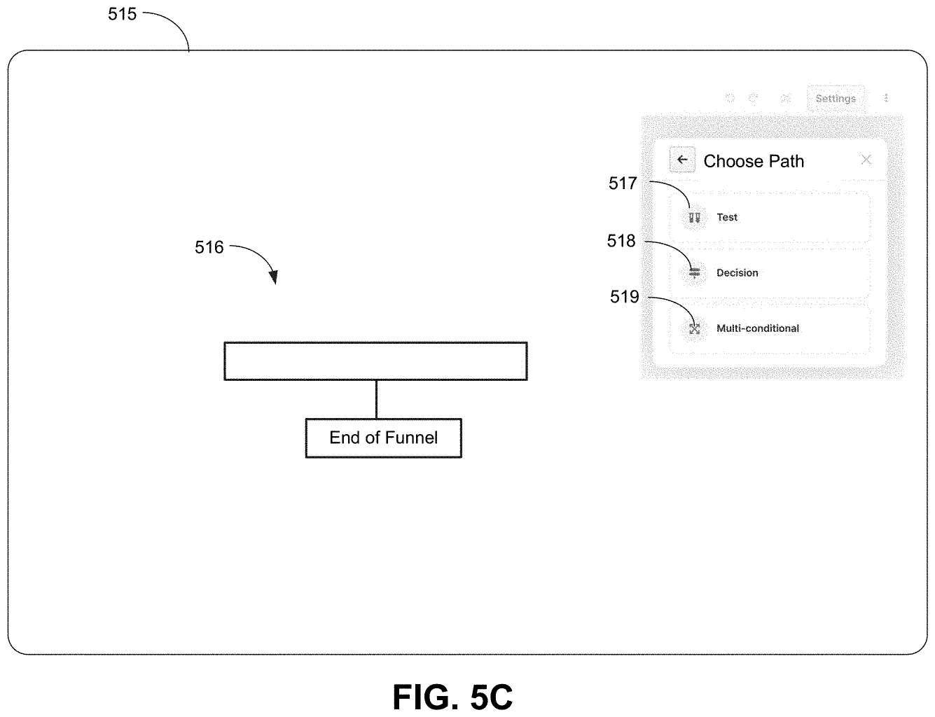

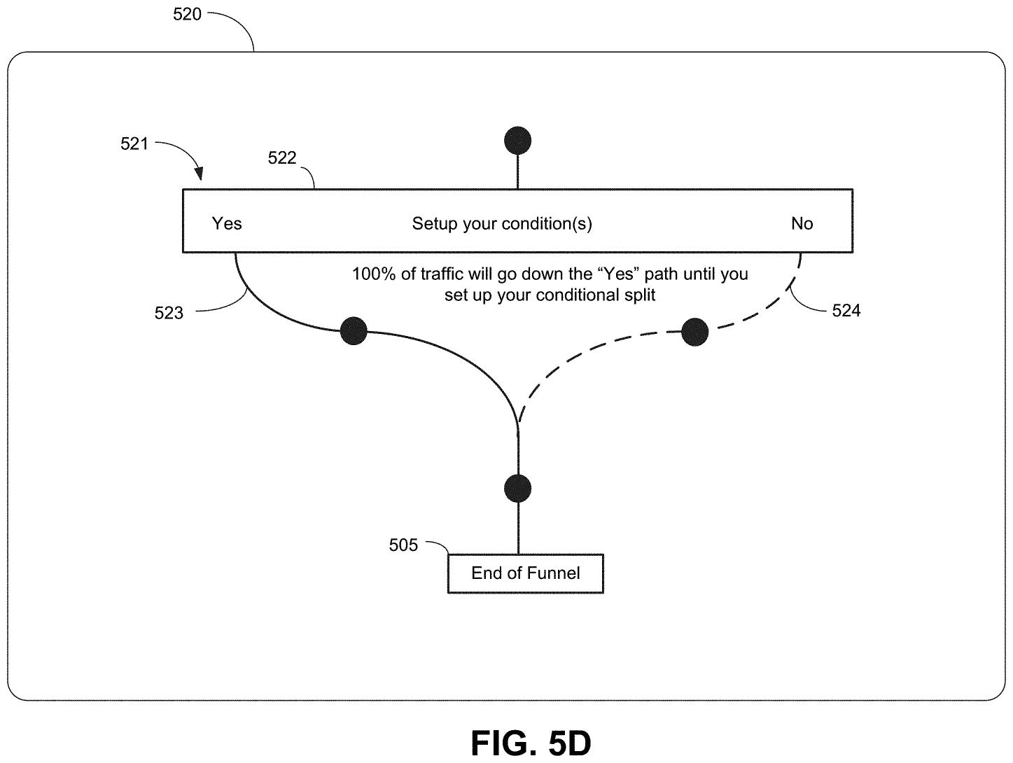

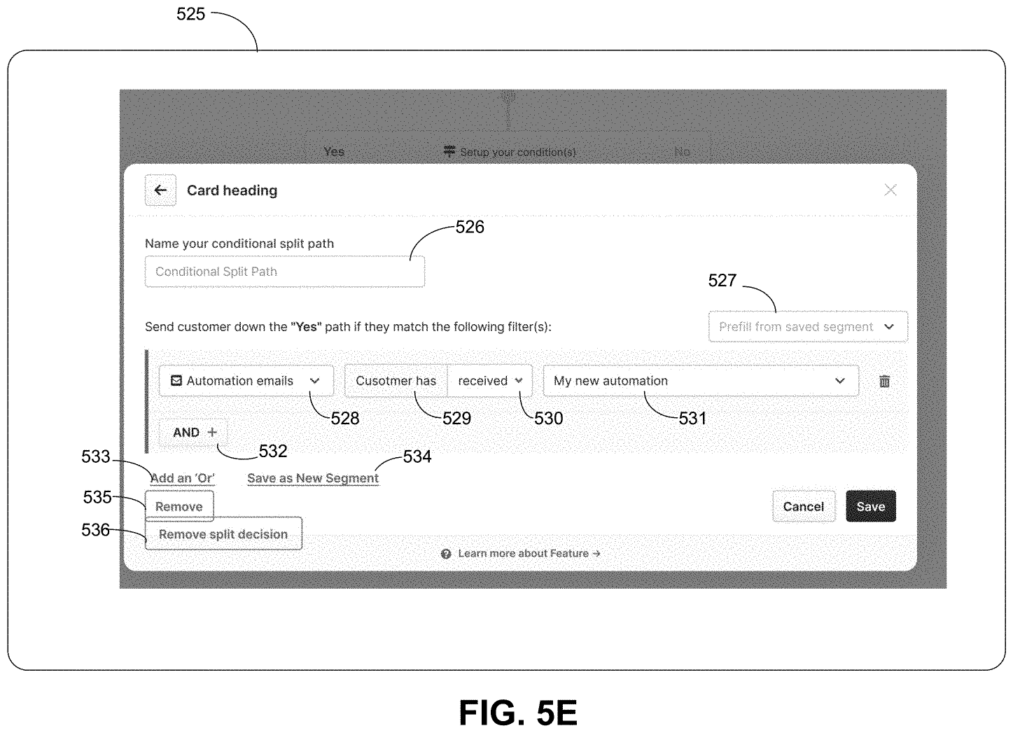

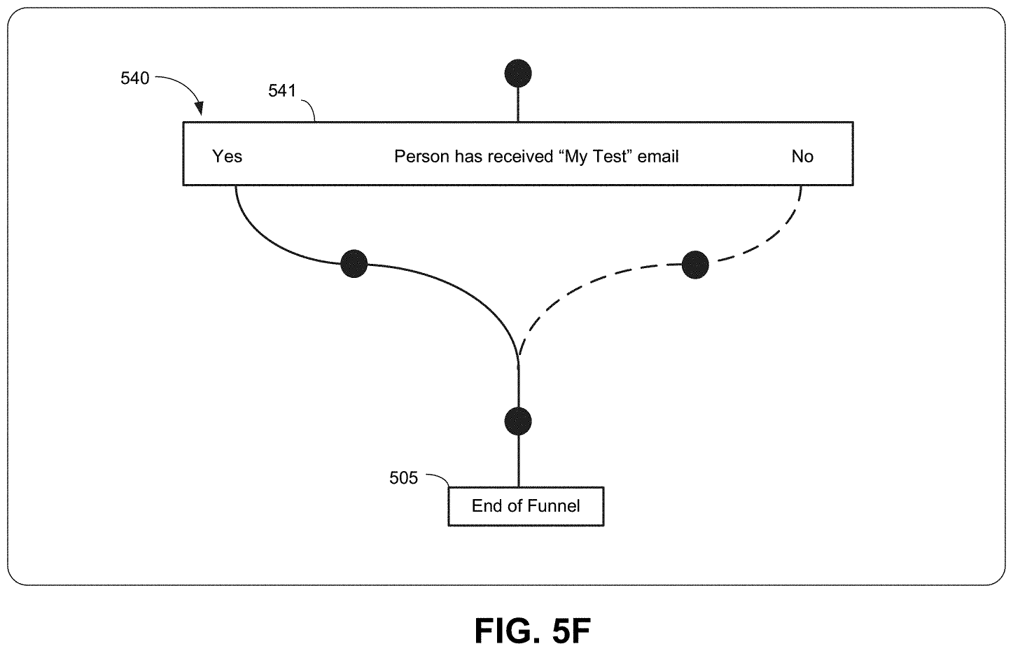

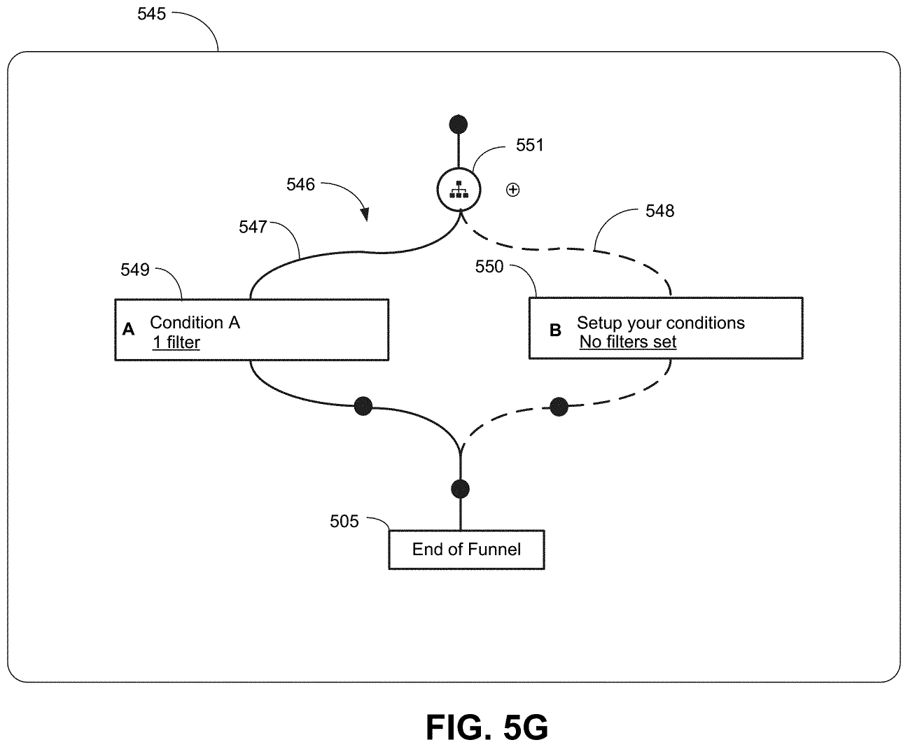

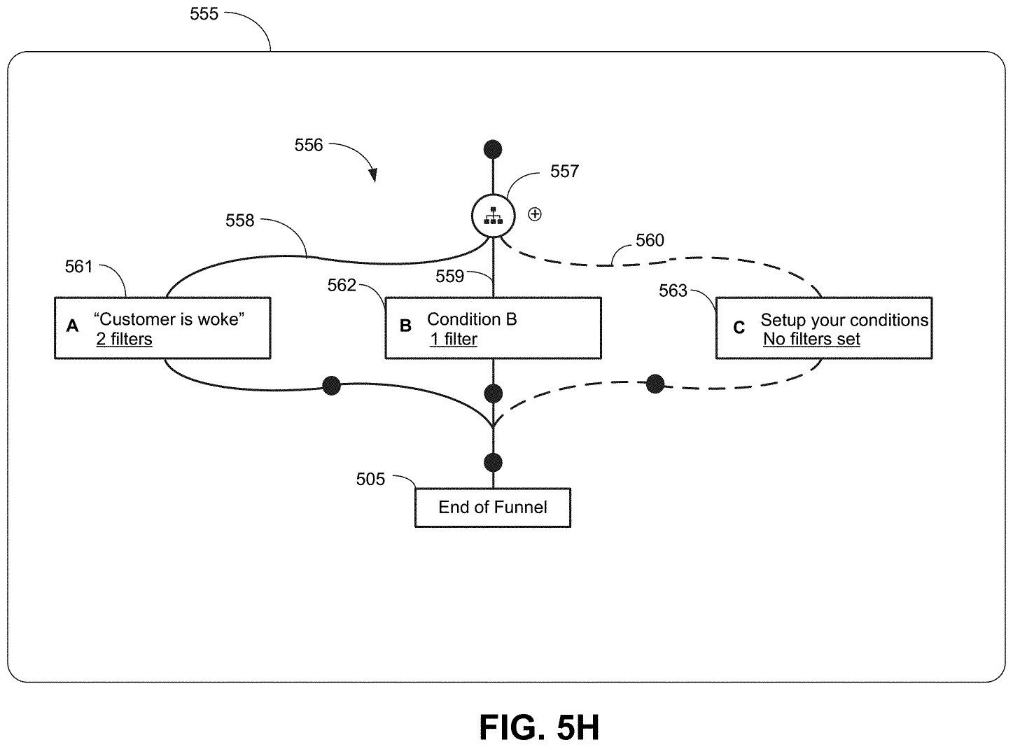

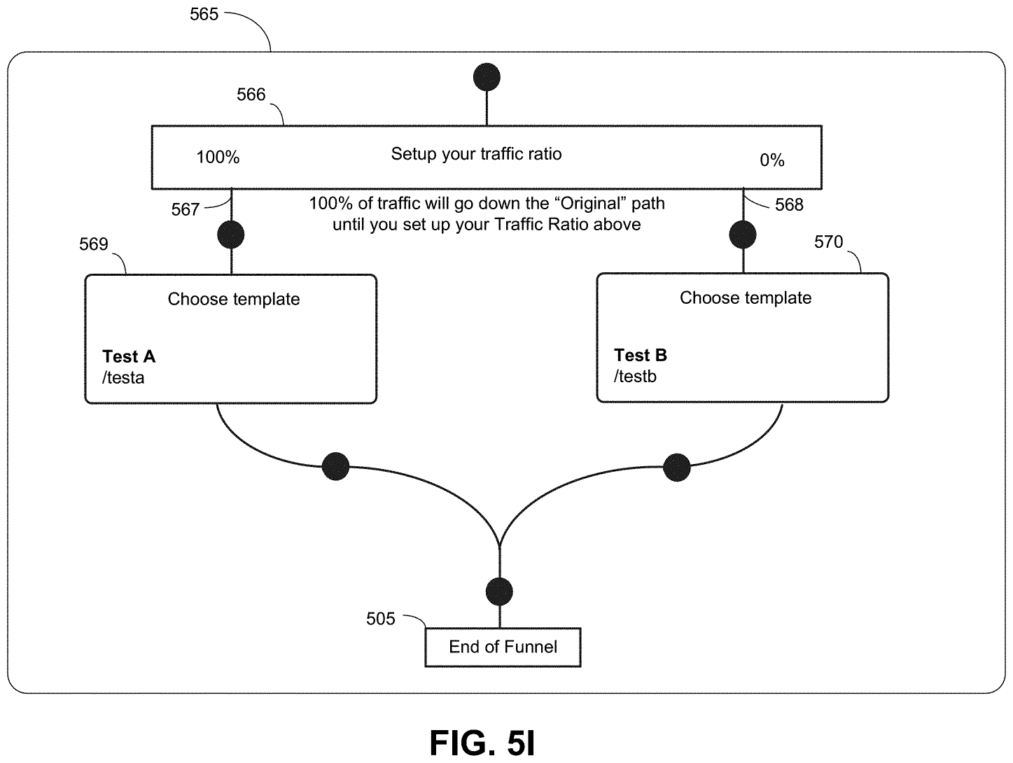

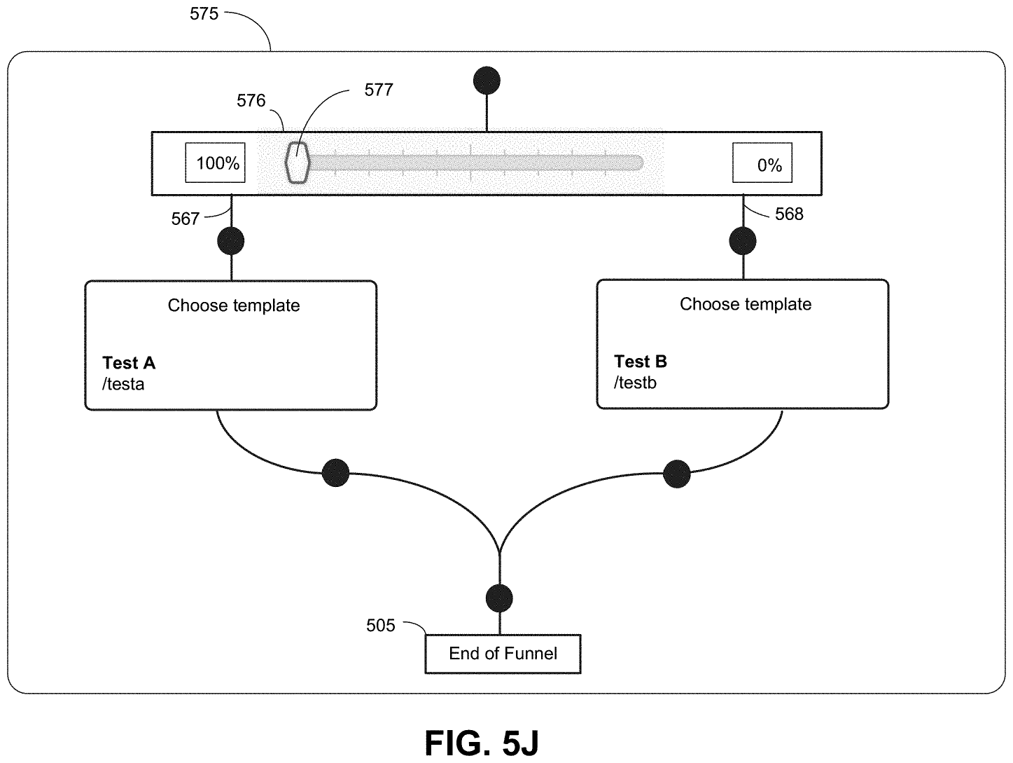

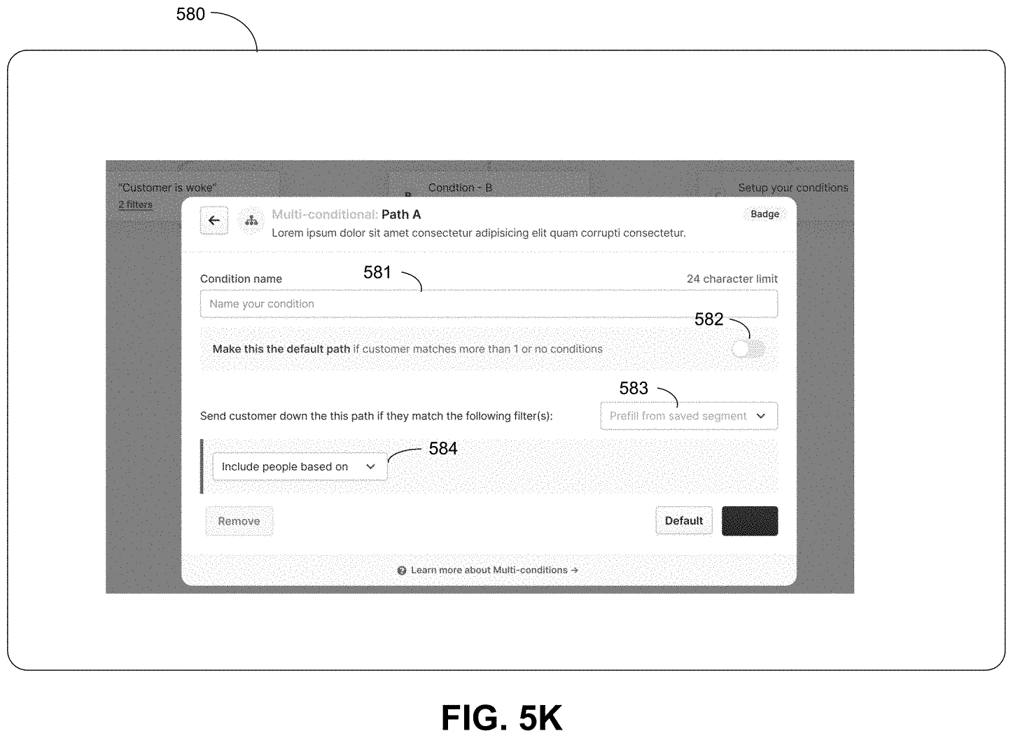

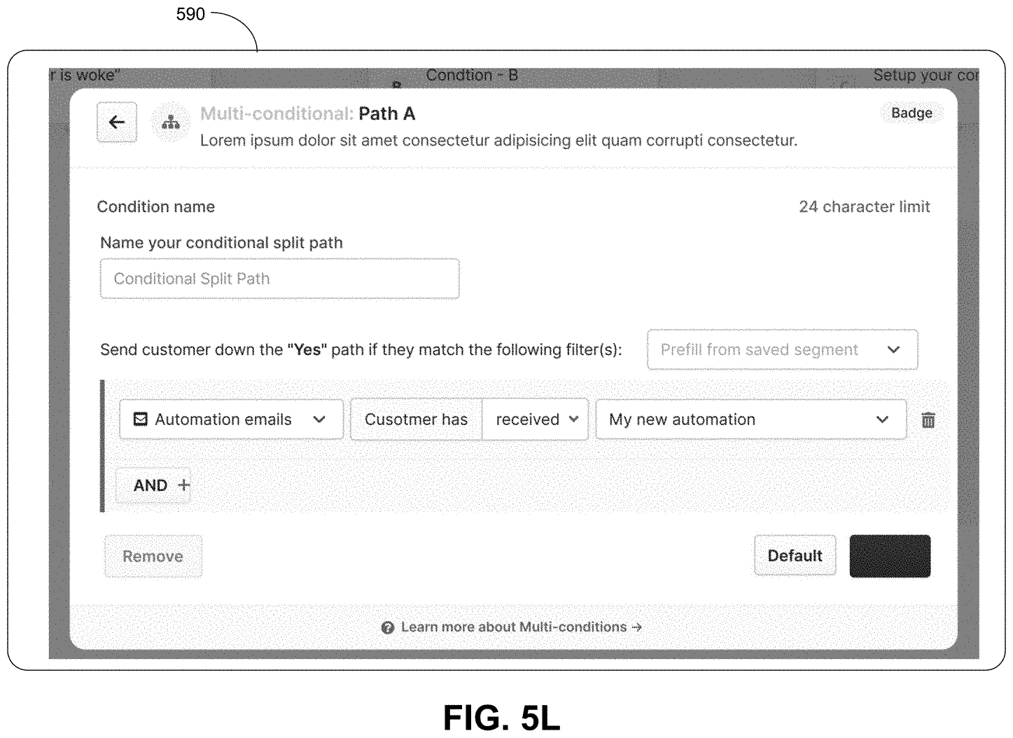

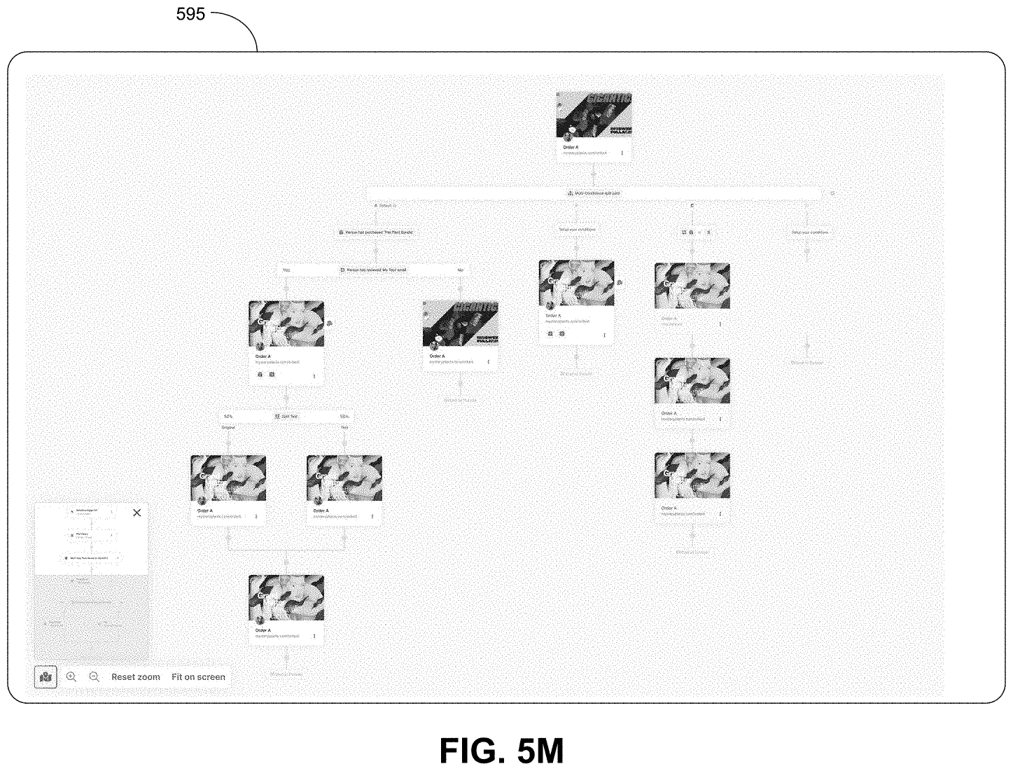

Furthermore, the website creation and operation system 112 may enable a system administrator to create one or more conditional splits. As used herein, the term “conditional splits” may refer to a determination by the website creation and operation system 112 that a particular branch of a tree of webpages is to be provided to an end user 118 upon satisfaction of a predetermined condition. For example, a system administrator may choose to create a conditional split such that an end user 118 who has already purchased a particular product or service will not receive any suggestions to purchase the same product or service. The conditional splits are described in more detail below with respect to FIGS. 2A-2B and 5A-5M.

In particular embodiments, the website creation and operation system 112 may be capable of linking a variety of entities (e.g., third-party system(s) 114 and guests). As an example and not by way of limitation, the website creation and operation system 112 may enable users (e.g., guests of a website created and operated via the website creation and operation system 112) to interact with each other as well as receive content from third-party system(s) 114 (e.g., payment processors, social media networks, website monitoring services, email platforms) or other entities, and/or to allow guests of a website created via the website creation and operation system 112 to interact with these entities through an application programming interfaces (API) or other communication channels.

In particular embodiments, a website creation and operation system 112 may include one or more types of servers, one or more data stores, one or more interfaces, including but not limited to APIs, one or more web services, one or more content sources, one or more networks, or any other suitable components, e.g., that servers may communicate with. In this sense, the website creation and operation system 112 may provide a platform, or backbone, which other systems, such as third-party system(s) 114, may use to provide website creation and monitoring services and website operation services and functionality to guests of a website created via the website creation system.

As shown in FIG. 1, in some embodiments, the website creation and operation system 112 can include a database 116. As is described in greater detail below in regard to FIGS. 2A-2B, the website creation and operation system 112 can utilize the database to store contact data packages and generated websites.

In some embodiments, the client device 104 includes a client application 106 installed thereon. In one or more embodiments, the client application 106 can be associated with the website creation and operation system 112. For example, the client application 106 allows the client device 104 to directly or indirectly interface with the website creation and operation system 112. The client application 106 also enables the user 102 (e.g., system administrator) to create, monitor, and edit websites via the website creation and operation system 112 and the client device 104. For example, the client application 106 can include a web browsing application and/or a website creation and operation application.

The third-party system(s) 114 may include additional systems that may interface with the website creation and operation system 112. For example, in some embodiments, the third-party system(s) 114 may include social media networks (e.g., Facebook®, Twitter®, Google® Plus, etc.) with which the website creation and operation system 112 may share and/or acquire information related to traffic on a created web site. In additional examples, the third-party system(s) 114 may include payment processors (e.g., Paypal, VISA Pay, Stripe, NMI, etc.) that enable guests to complete purchases on a created website. In further embodiments, the third-party system(s) 114 may include website monitoring systems, email platforms, etc.

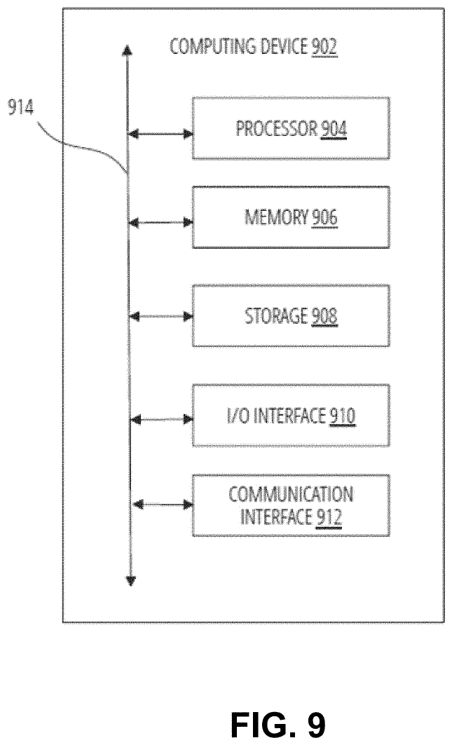

Both the client device 104 and the server(s) 110 (and the website creation and operation system 112) can represent various types of computing devices with which guests can interact. For example, the client device 104 and/or the server(s) 110 can be a mobile device (e.g., a cell phone, a smartphone, a PDA, a tablet, a laptop, a watch, a wearable device, etc.). In some embodiments, however, the client device 104 and/or server(s) 110 can be a non-mobile device (e.g., a desktop or server). Additional details with respect to the client device 104 and the server(s) 110 are discussed below with respect to FIG. 9.

The end user 118 may include a client device similar to client device 104, with which an individual may interact with the website created by the website creation and operation system 112. The end user 118 client device may include applications such as web browser which permit the individual (e.g., guest to the created website) to display webpages of the website and interact with the displayed webpages. Data related to the end user 118 may be stored in the end user 118 client device, the server(s) 110, or the third-party system(s) 114.

FIGS. 2A-2B illustrate a sequence-flow diagram 200 that a website creation and operation system 112 can utilize to create and operate a website including a series of directional webpages that are configured to elicit a particular user interaction with the website. The client device 104, end user 118, third-party system(s) 114, and website creation and operation system 112 shown in FIGS. 2A-2B may be as described with reference to FIG. 1.

The website creation and operation system 112 may receive a selection to create a website from the client device 104, as shown in act 202 of FIG. 2A. For example, upon detecting a user interaction to create a website, the client device 104 and/or the client device application 106 can provide an indication of the user interaction to create a website to the website creation and operation system 112. In one or more embodiments, the website creation and operation system 112 can receive the selection to create a website through the network 108.

Upon receiving the selection to create a website, the website creation and operation system 112 creates a website including a series of directional webpages, as shown in act 204 of FIG. 2A. In some embodiments, the series of directional webpages are configured to elicit and/or cause an end user interaction with the website. The series of directional webpages may refer to a series (e.g., a sequence or a flow) of webpages that are ordered, configured, and/or designed to entice (e.g., elicit, encourage, prompt, evoke, cause, etc.) at least one particular user interaction within the website. For instance, the series of directional webpages may funnel (e.g., direct, aim, etc.) a guest of the website toward a particular user interaction. In one or more embodiments, the series of directional webpages may include a tree of webpages that are configured to be provided to the end user 118 during interaction with the website during a single or multiple web browsing sessions. The tree of webpages may include at least two branches that include possible paths to be provided to the end user 118 during interaction with the website. In some embodiments, the particular user interaction (e.g., the sought-after user interaction) may include one or more of remaining on webpages of the website, opting into an email list, opting into receiving push messages via a social media network, application or web browser, providing contact information (e.g., an email address, a telephone number, a social media identifier, etc.), sharing a portion of the website on social media, completing a purchase, accepting an up-sell option, completing multiple purchases, adding an item to a cart, visiting another website, interacting with a chat messenger, viewing a video on the website, interacting with a webinar, viewing an image on the website, etc.

As noted above, in some embodiments, each webpage of a series of directional webpages may be presented in a single browsing session. In other embodiments, webpages of a series of directional webpages may be presented in multiple different browsing sessions. For instance, a first webpage of a series of directional webpages may be presented in a first browsing session, and a second webpage of a series of directional webpages may be presented in a second browsing session (e.g., a second browsing session initiated in response to an interaction within an email sent to a guest by the website creation and operation system 112). In some embodiments, the second webpage of a series of directional webpages may be a branch of a tree of webpages presented upon satisfaction of certain predetermined conditions.

The website creation and operation system 112 may further receive a selection to create a conditional split in the tree of webpages, as shown in act 206. The website creation and operation system 112 may create a conditional split responsive to the selection to create a conditional split received from the client device 104, as shown in act 208. In some embodiments, one of the at least two branches discussed in act 204 is to be provided to the end user 118 upon satisfaction of a predetermined condition associated with the conditional split. In some embodiments, the predetermined condition may be related to one or more of a guest's social media accounts, the guest's demographics, and/or the guest's actions within the system administrator's website, (e.g., user clicks, user mouse hovering information, time spent on particular webpages of the site, etc.). The predetermined condition may further be related and based on whether or not the guest has made a purchase within the system administrator's website, whether or not the guest has interacted with a communication broadcast (e.g., an email broadcast, text message broadcast, notification broadcast, social media broadcast, an instant messenger broadcast, a webinar broadcast) sent or hosted from the system administrator's website, whether or not the guest the guest is listed on a communication list (e.g., an email list) related to the system administrator's website, and/or whether or not the guest has interacted with an email from the system administrator's website including a link to at least one page within a series of directional webpages or the website. Each of the foregoing predetermined conditions is described in greater detail below.

As noted above, the predetermined condition may be related to a guest's social media accounts. For instance, the predetermined condition may relate to how many followers the guest has within a social media network, how many social media users the guest is following within a social media network, and whether or not the guest has an account within a particular social media network.

As mentioned above, the predetermined condition may be related to the guest's demographic and/or other labels and tags. For example, the predetermined condition may relate to the guest's name, address, location, age, gender, email address, telephone number, tags, and a recency of the most recent action performed by the guest in relation to the system administrator's web site.

As also noted above, the predetermined condition may be related to the guest's actions within the system administrator's website. As a non-limiting example, the predetermined condition may relate to whether or not the guest has visited a particular webpage within a series of directional webpages of the system administrator's website.

As also mentioned above, the predetermined condition may be related to whether or not the guest has made a purchase within the system administrator's website. As a non-limiting example, the predetermined condition may relate to whether the guest has ever made a purchase on the creator's website, how many purchases the guest has made on the creator's website, how much money the guest has spent on the creator's website, and a recency of a most recent purchase.

As discussed above, the predetermined condition may be related to whether or not the guest has interacted with a communication broadcast (e.g., an email broadcast, a text message broadcast, a notification broadcast, a social media message broadcast, an instant message) sent from the system administrator's website. For instance, the predetermined condition may relate to whether or not the guest opened and/or viewed the communication broadcast or whether or not the guest clicked on the communication broadcast. In additional embodiments, the term “broadcast” may also refer to a webinar broadcast, and the at least one rule may relate to whether or not a guest interacted (e.g., clicked) on a webinar provided by the webinar broadcast.

As also discussed above, the predetermined condition may be related to whether or not the guest is listed on a list related to the system administrator's website. For example, the predetermined condition may relate to whether the guest is listed on one or more of a communication list (e.g., an email list or a communication broadcast), an opt-in list, or a static list.

Additionally, as discussed above, the predetermined condition may be related to whether or not the guest has interacted with an email (e.g., an email from the system administrator's website) including a link (e.g., a hyperlink) to at least one webpage within a series of directional webpages of the website. In particular, the predetermined condition may relate to whether the guest has opened an email including the link to at least one webpage within the series of directional webpages of the website. Additionally, the rule may relate to whether the guest has clicked (e.g., selected) the link within the email.

In some embodiments, the predetermined condition may be a combination or group of predetermined conditions. For instance, the web site creation and operation system 112 may create a conditional split in the tree of webpages wherein a branch is to be provided to the end user upon satisfaction of more than one predetermined condition. For example, the branch may be provided to the end user responsive to the satisfaction of at least three, at least four, or at least five predetermined conditions. In some instances, each of the predetermined conditions may relate to different filters, and in other embodiments, two or more of the predetermined conditions may relate to a same filter.

Referring to FIG. 2B, in some embodiments, upon creating the conditional split, the web site creation and operation system 112 receives an indication of a user interaction by a guest with the creator's website (e.g., an end user 118), as shown in act 210 of FIG. 2B. For instance, a client device associated with the end user 118 may detect a user interaction by the guest via an application, such as a web browser, and may provide an indication of the user interaction to the web site creation and operation system 112.

In some embodiments, upon receiving an indication of a user interaction, the website creation and operation system 112 may acquire data (e.g., a data package) related to a user, as shown in act 212. The acquired data may be related to the guest of the website and received from a third-party system(s) 114. As used herein, the term “acquires” may include the website creation and operation system 112 requesting and receiving the data related to a user from the third-party system(s) 114 or merely receiving the data related to a user from the third-party system(s) 114.

In some embodiments, as noted above, the third-party system(s) 114 may include one or more of a social media network, a payment processor, an email provider, etc. Furthermore, the data may include information, such as, whether the guest has an account with the social media network, a number of followers of the guest's social media account within the social media network, a number of social media accounts the guest's social media account is following, purchases made through the payment processor, whether emails from the creator's website were opened, etc.

In response to acquiring data related to an end user, the website creation and operation system 112 may query the acquired data related to the end user, as shown in act 214 of FIG. 2B. In particular, the web site creation and operation system 112 may query the acquired data to determine whether the acquired data satisfies one or more predetermined conditions, as shown in act 216 of FIG. 2B. In some embodiments, the website creation and operation system 112 compares the acquired data to the one or more predetermined conditions. As a non-limiting example, if the predetermined condition includes that the end user has purchased a particular product on the system administrator's website, the website creation and operation system 112 may determine whether the acquired data indicates that the end user has purchased the particular product.

Upon determining that the acquired data satisfies the one or more predetermined conditions, the website creation and operation system 112 may provide one of that at least two branches to the end user, as shown in act 218 of FIG. 2B. Each branch may correspond to a particular satisfied condition. For example, if the queried data indicates that an end user has already purchased a particular product, the website creation and operation system 112 may provide a branch of the tree that includes displaying a product that is related to, but distinct from, the purchased product.

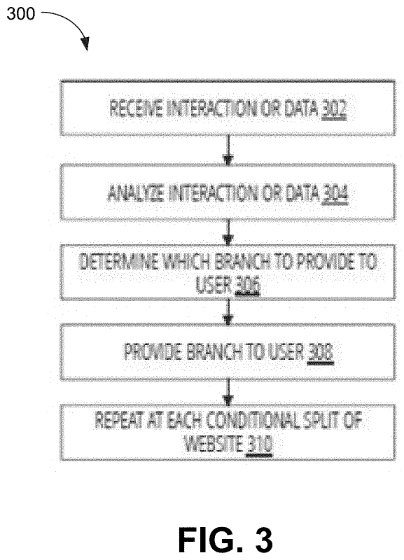

FIG. 3 illustrates a flow chart depicting an exemplary method 300 of determining and providing a branch of a tree of webpages to a user, in accordance with one or more embodiments of the present disclosure. The method 300 may include receiving an interaction or data from an end user (e.g., end user 118), as shown in step 302. The website creation and operation system 112 on server(s) 110 may receive the interaction or data. The interaction may be any kind of user input from a guest or visitor to a website created by the website creation and operation system 112. For example, the interaction may include a mouse click on a link or a touch on a touch screen. The data that is received may include, by way of example, a history of end user 118 interactions with the website (e.g., products/services purchased, products/services currently or historically in a guest's “cart,” links clicked on, videos watched, etc.), an IP address of the end user 118, a GPS location of the end user 118, cookies associated with the client device of the end user 118, social media data, and/or demographic information of the end user 118.

The method 300 may further include analyzing the received interaction or data, as shown in step 304 of FIG. 3. In this regard, a processor (FIG. 9) analyzes the received data and executes the required instructions.

The method 300 may also include determining which branch of the tree of webpages to provide to the end user 118, as shown in step 306 of FIG. 3. In some embodiments, the branch is determined using a table where conditions correspond with branches to be provided to the end user 118. If certain conditions are met/satisfied, then the website creation and operation system 112 may use the table to look up the corresponding branch webpage that should be provided to the end user 118.

Additionally, the method includes providing the determined branch of the tree of webpages to the end user 118, as shown in step 308 of FIG. 3. The webpage corresponding the determined branch may be provided to the end user 118 via the network 108 for display on the client device of the end user 118. As the end user 118 receives the branch webpage of the tree of webpages, the end user 118 may further interact with the provided branch webpage. This further interaction may be provided to the website creation and operation system 112 for further analysis and determination of a next branch to be provided to the end user 118. Accordingly, the method 300 may repeat at each conditional split of the website, as shown in step 310.

FIG. 4 illustrates a non-limiting example tree 400 of webpages including conditional splits and branches to be provided to an end user, in accordance with one or more embodiments of the present disclosure. The tree 400 may be an example architecture of a website created and operated by the website creation and operation system 112 of FIG. 1. The tree 400 may also be an example of a website with which the end user 118 interacts. Each horizontal line of FIG. 4 (e.g., 402-408) represents a conditional split, while each vertical arrow (e.g., 410-414) represents a branch of the tree 400. Each branch is a webpage in a series of directional webpages, as described herein.

During one or more browsing sessions, an end user (e.g., end user 118) may arrive at a conditional split, such as conditional split 402, upon which an interaction or data is provided to the website creation and operation system 112. The website creation and operation system 112 analyzes the interaction or data and determines which branch to provide to the end user 118. In the non-limiting example depicted in FIG. 4, there are three possible branches (e.g., branch 404, 406, or 408) to provide to the end user 118 upon satisfaction of a predetermined condition associated with the conditional split. One of branches 404-408 may be a default branch that is provided if none of the predetermined conditions are met. Once the website creation and operation system 112 determines which branch to provide to end user 118, the website creation and operation system 112 may provide the determined branch to the end user 118. If, for example, the determined branch is branch 410, the end user 118 may encounter an additional conditional split 404. The end user 118 may interact with the website, which may prompt a repeated process of interaction, analysis, and determining which branch to provide to the end user 118. In the case of conditional split 404, there are only two possible branches that may be provided to the end user 118. Each branch 416 and branch 418 lead to another conditional split 420 and conditional split 422, respectively. This process of navigating the tree 400 of webpages may continue until a desired response from the end user 118 is achieved, such as, for example, purchasing a product or opting into email communications. In some embodiments, two or more branches may converge at a subsequent point in the tree 400 and may become a single branch (not shown in FIG. 4).

FIGS. 5A-5M illustrate user interfaces depicting a method for creating a directional site, or funnel, according to an exemplary embodiment of the present disclosure. Specifically, FIG. 5A is an exemplary GUI 500 of a directional site or funnel 501 being created. In the illustrated embodiment the funnel 501 under creation comprises a starting point 502 that the user selects to add a step and an “End of Funnel” 502 that signals the end point of the funnel 501. A window 504 illustrates options available for selection by the user. In this example, the user may either select a “page” option 505 or a “split path” option 506.

If the user selects the page option 505, the user will then have the option to select a landing webpage that will be displayed. If the user selects the split path option 506, the user will then go on to define the split path as further discussed herein.

FIG. 5B is an exemplary GUI 510 illustrating the beginning of a funnel 511 for a split path option. In this GUI, the user can select between a “conditional split” option 512 and a “split test” option 513. If the user selects the conditional split option 512, the traffic path will be split based upon custom filters and values chosen, as further discussed herein. If the user selects the split test option 513, the traffic path is split based upon random distribution or custom traffic ratios. Custom traffic ratios are discussed further herein with respect to FIG. 5I.

FIG. 5C is an exemplary GUI 515 illustrating the options for building a funnel 516 with a conditional path. A user may select a test path 517, a decision path 518, or a multi-conditional path 519. If a test path 517 is selected, a path is created for test/marketing purposes. If a decision path 518 is selected, the user will have an option to set up a single conditional path, as further discussed with respect to FIG. 5D herein. If a multi-conditional path 519 is selected, the user will have the option to set up multiple conditional paths, as further discussed herein with respect to FIGS. 5G-5I herein.

FIG. 5D is an exemplary GUI 520 illustrating the creation of an exemplary single-conditional funnel 521 under construction. A condition block 522 displays a condition from the user after the condition is defined by the user, as further discussed herein with respect to FIG. 5E. The condition block comprises a “Yes” path 523 and a “No” path 524. 100% of traffic will go through the “Yes” path until a conditional split is defined by the user, as further discussed herein.

FIG. 5E is an exemplary GUI 525 illustrating how a user defines a conditional split path, which will be displayed in the condition block 522 (FIG. 5D) after creation. In an input field 526 the user inputs a name for the conditional split path. An input field 527 allows a user to prefill from a saved segment.

The user defines the conditional split path options by selecting from a first dropdown menu 528 from predefined options. In the illustrated example, the user has selected “Automation emails.” Other non-limiting examples of dropdown options for menu 528 include “Enrolled in Course,” “Bought Product,” “Bought Product Variant,” “Opted in on Funnel Step,” “Viewed Funnel Step,” “Viewed Product Page,” “Contact Details,” and “Has Tag.”

Input field 529 is populated automatically based upon the first dropdown menu 528 option chosen. Input field 530 has a dropdown menu that allows the user to select an action related to the input field 529. In the exemplary embodiment, the fields 529 and 530 are “Customer has” and “received,” respectively. Other non-limiting examples of dropdown options for fields 529 and 530 include “Enrolled in Course,” “Bought Product,” “Bought Product Variant,” “Opted in on Funnel Step,” “Viewed Funnel Step,” “Viewed Product Page,” “Contact Details,” and “Has Tag.”

Input field 531 has a dropdown menu that allows the user to select a word or phrase related to the option chosen in field 530. In the exemplary embodiment, the user has chosen “my new automation.” The result of the choices in this example are that the funnel will go down the “Yes” path if the customer has received “my new automation” emails.

Connector box 532, if selected by the user, allows the user to add a new condition. “Or” selection 533 allows a user to set up an “Or” condition. Option 534, if selected by the user, saves for future filtering of a group of visitors/contacts throughout other features of the app and can be used in other conditional steps.

A “Remove” option 535 will clear the condition set if selected. A “Remove split decision” option 536 will clear out a second decision set up by the user, while leaving the original decision set up intact.

FIG. 5F illustrates an exemplary funnel 540 that a user has set up using the GUIs of FIGS. 5A-5E. The funnel 540 will send customers down the “Yes” path if the customer has received a “My Test” email, and down the “No” path is the customer has not received a “My Test” email.

FIG. 5G is an exemplary GUI 545 illustrating how a user defines a funnel 546 with a dual split path. In a first path 547, the user may set up a “Condition A” 549 in the manner discussed above with respect to FIG. 5E. In a second path 548, the user may set up a “Condition B” 550 in the same manner. Whether the funnel path will proceed down the first path 547 or the second path 548 will depend on a condition 551 that the user will set in the manner discussed herein.

FIG. 5H is an exemplary GUI 555 illustrating a funnel 556 with a three-way split path. In a first path 558, the user has set up a “Condition A” 561 of “Customer is woke” with two filters. In a second path 559, the user has set up a “Condition B” 562 with one filter. A third path 560 with a “Condition C” 563 has yet to be created. Whether the funnel path will proceed down the first path 558, the second path 559, or the third path 560 will depends on a condition 557 that the user will set.

FIG. 5I is an exemplary GUI 565 illustrating how a user may set up a custom traffic ratio, as discussed above with respect to FIG. 5B. A ratio box 566 is displayed to show the traffic ratio between a first path 567 and a second path 568. 100 percent of traffic will go down the first path 567 until the user sets up a different traffic ratio, as further discussed with respect to FIG. 5J herein.

In the first path 567, a template option 569 will display a user-chosen template, designated as “Test A” in the illustrated example. In the second path 570, a template option 570 will display a user-chosen template, designated as “Test B” in the illustrated example.

FIG. 5J is an exemplary GUI 575 similar to that shown in FIG. 5I, that further illustrates how a user selects a custom traffic ratio. In this regard, the ratio box 576 comprises a slider 577 that the user can slide to set the desired ratio of traffic between the two paths 567 and 568.

FIG. 5K is an exemplary GUI 580 that a user uses to select a path of a multi-conditional path: in this example, path A in FIG. 5H. A name field 581 allows a user to type in a name for the condition. A default selector 582, if selected by the user, makes the path A the default path if the customer matches more than one condition or no conditions. Field 583 allows a user to prefill from a saved segment. A dropdown field 584 allows the user to select a filter for sending a customer down the path; in this example, “Include people based on” has been selected. Other dropdown menu options are similar to those discussed above with respect to FIG. 5E.

FIG. 5L depicts a GUI 590 for defining Path A of a multi-conditional path. GUI 590 is similar to GUI 580 of FIG. 5K, except that in GUI 590 the user has defined a filter for the “Yes” path for Path A as the customer having received a “My new automation” email.

FIG. 5M depicts an exemplary funnel with a multiple split path showing graphically the web pages that will be displayed for each step in each path.

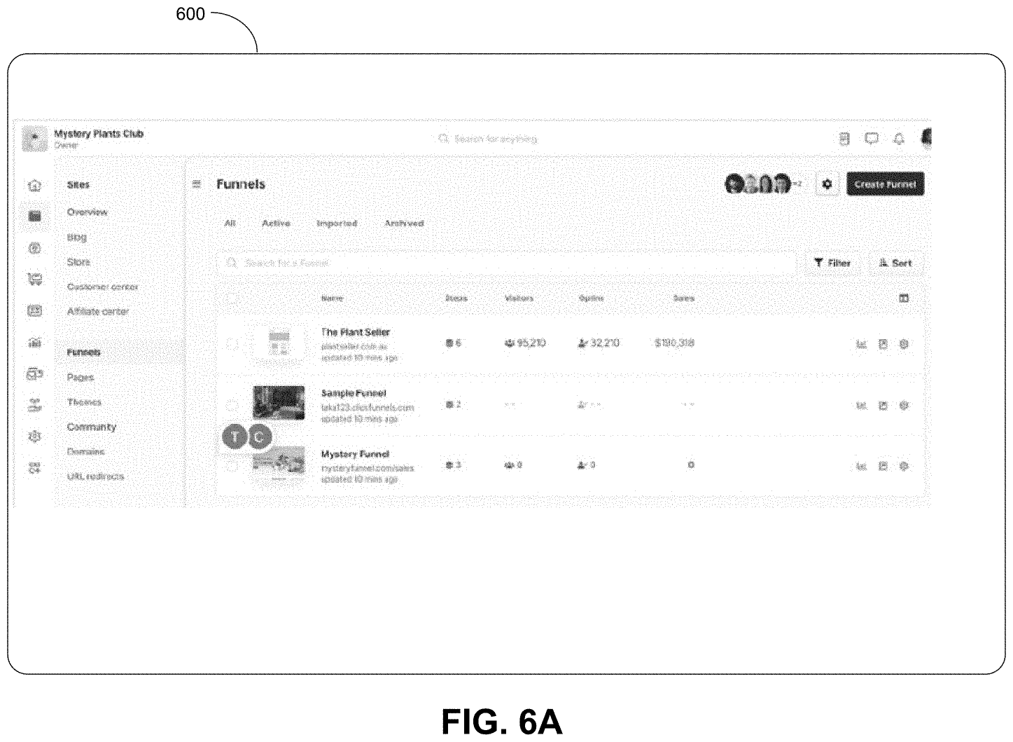

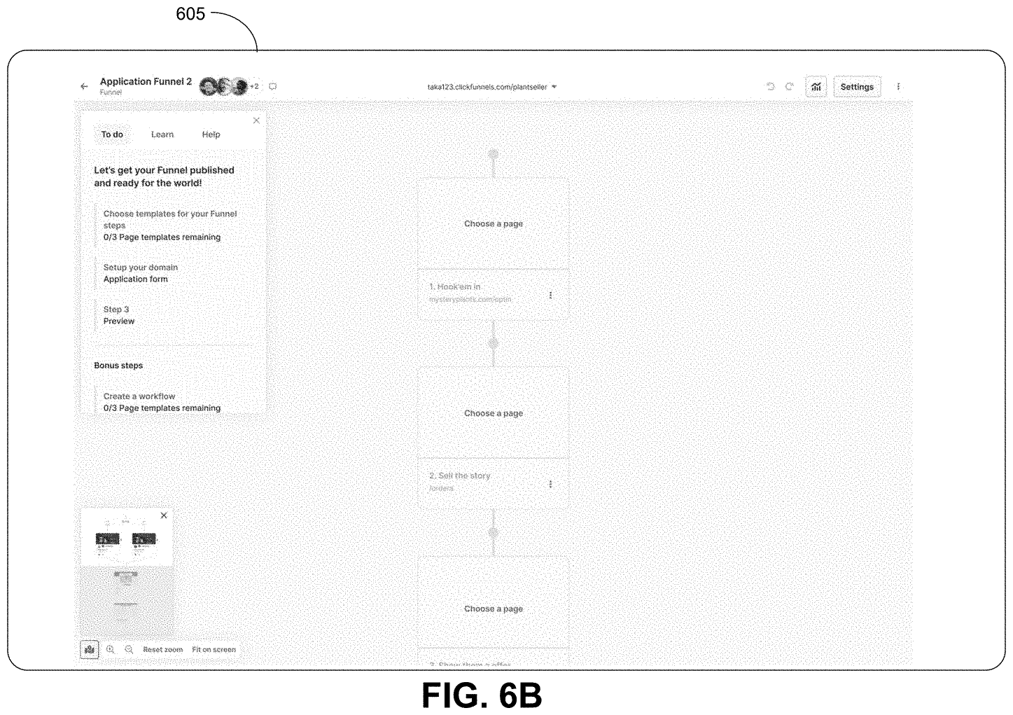

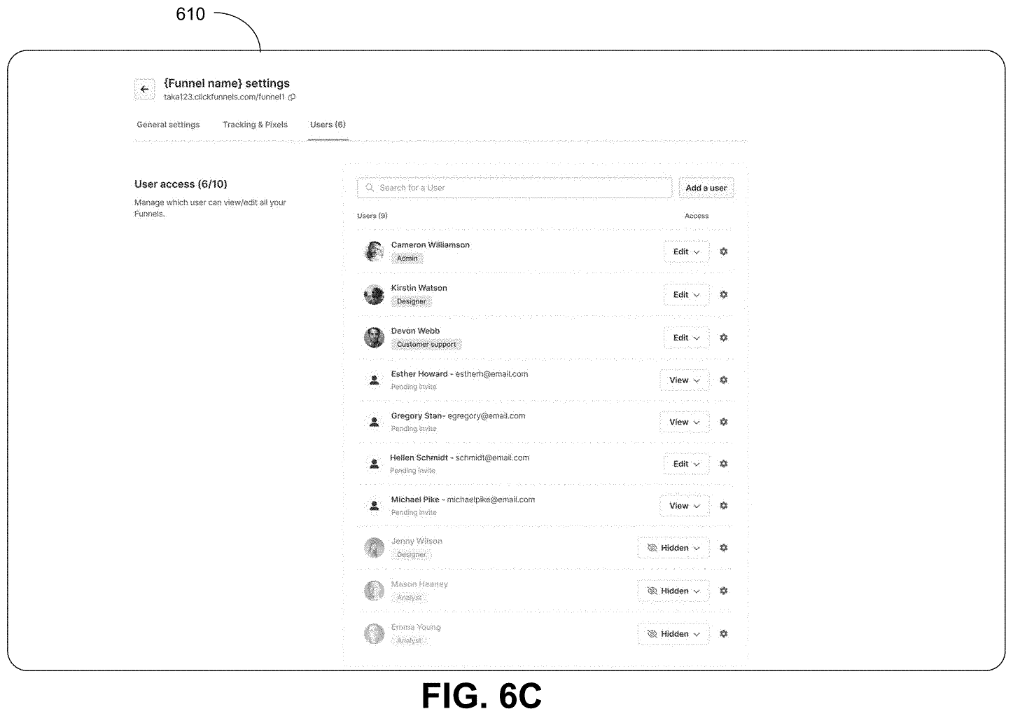

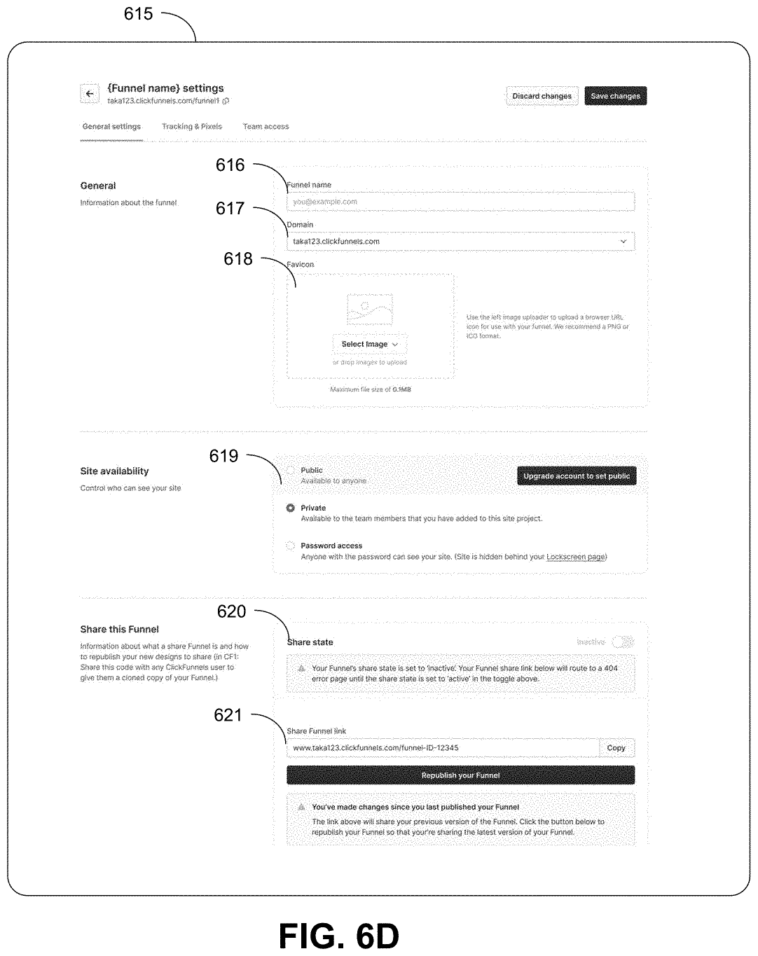

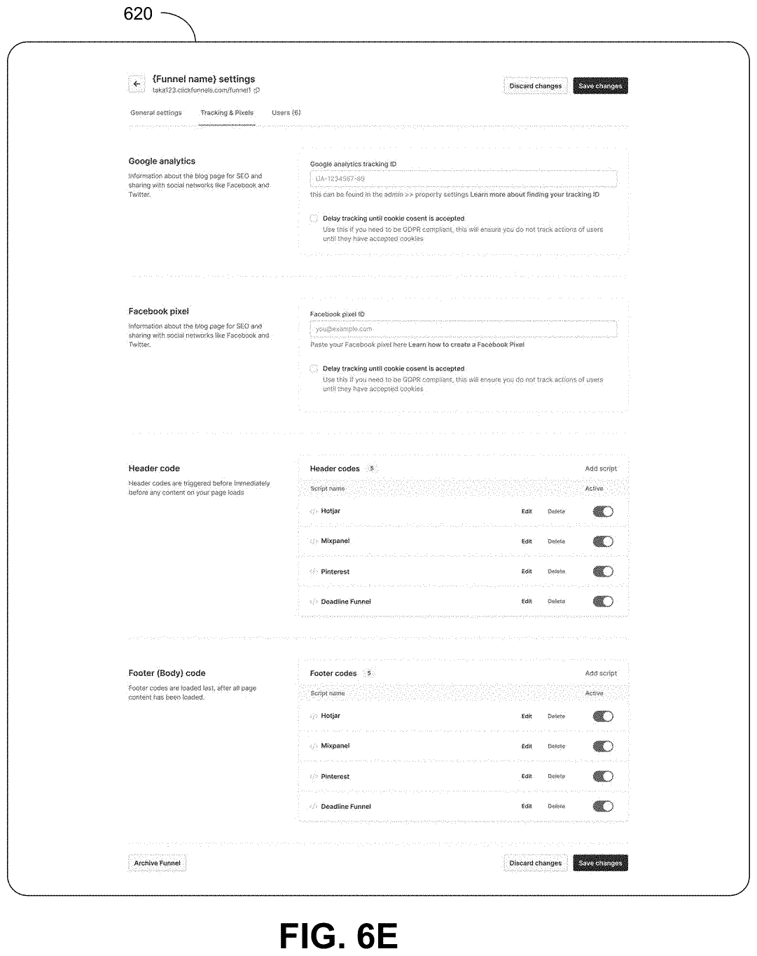

FIG. 6A depicts an exemplary GUI 600 showing funnels that have been created by a user, that may be selected for viewing or editing. For example, a first funnel 601 is “The Plant Seller” and comprises six steps 602. The site has had 95,210 visitors and 32,210 opt ins, with sales of $190,318.

FIG. 6B depicts an exemplary GUI 605 for users illustrating the process to create funnels.

FIG. 6C depicts an exemplary GUI 610 showing the exemplary users who are allowed access to view and edit funnels.

FIG. 6D depicts a settings GUI 615 according to an exemplary embodiment of the present disclosure. In this GUI, the user may set general attributes for a funnel, for example a funnel name 616, a domain location 617, an icon for the funnel 618, the site availability 619, and share information 620. A “Share Funnel Link” field 621 receives a link for a funnel that a user wants to be able to share with other users.

FIG. 6E depicts a second settings GUI 620 according to an exemplary embodiment of the present disclosure.

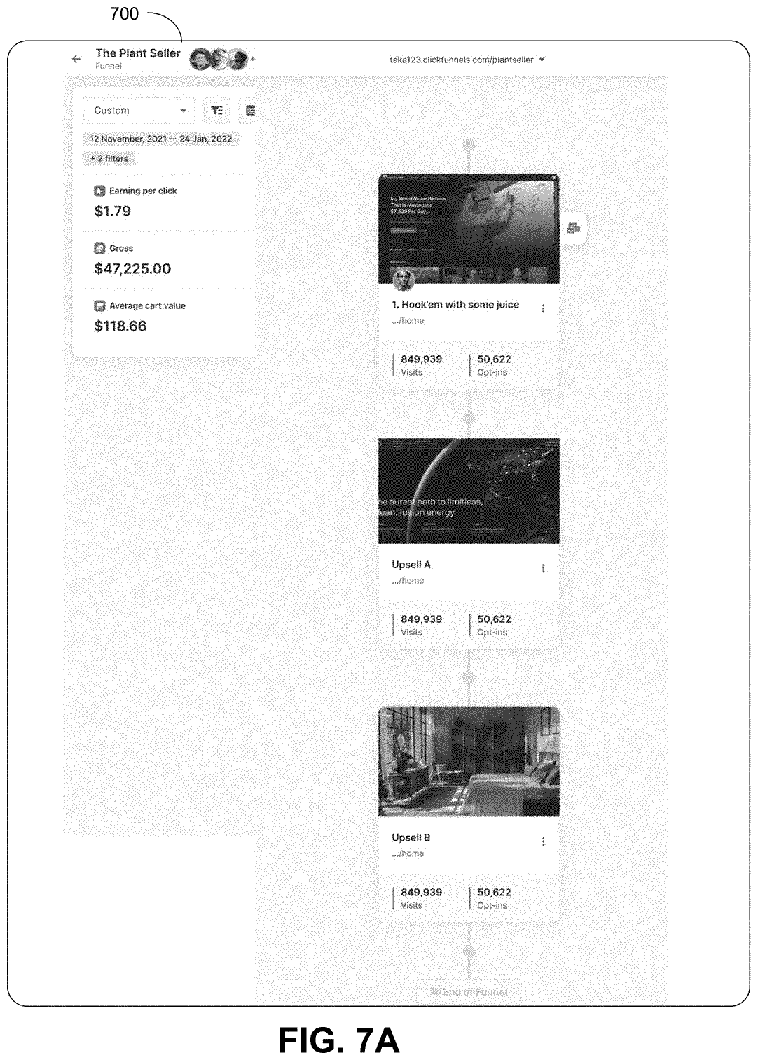

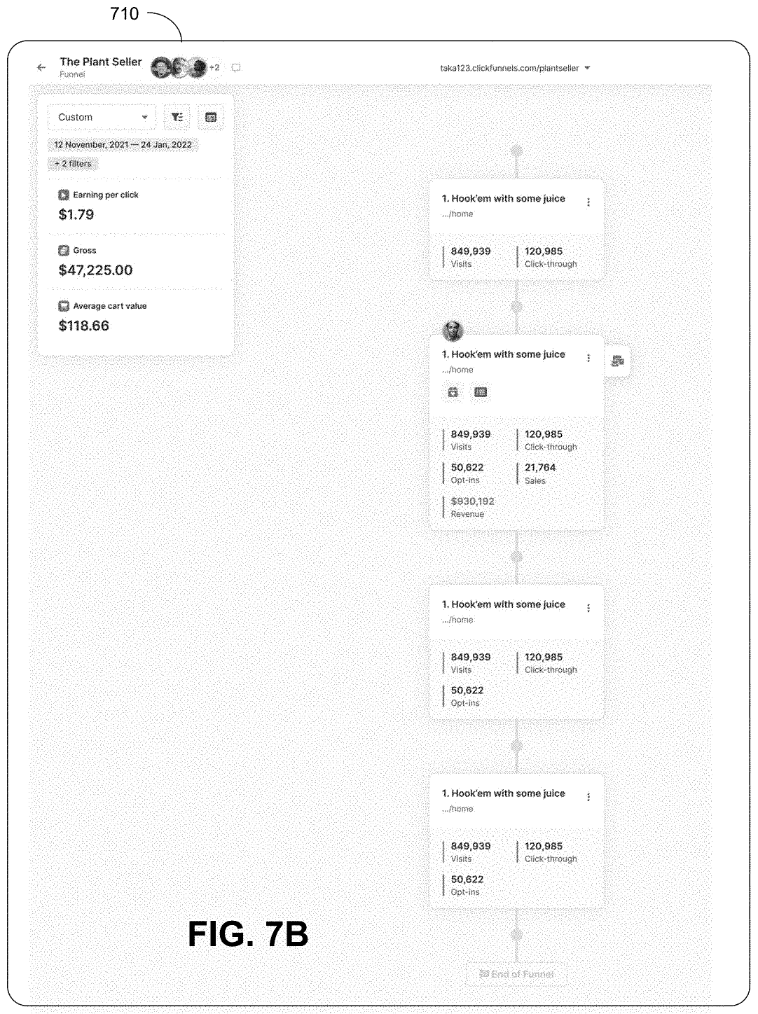

FIG. 7A depicts an exemplary GUI 700 for enabling a system administrator to display metrics related to webpages of the website, in accordance with one or more embodiments of the present disclosure.

FIG. 7B depicts a second exemplary GUI 710 for enabling a system administrator to display metrics related to webpages of the website, in accordance with one or more embodiments of the present disclosure.

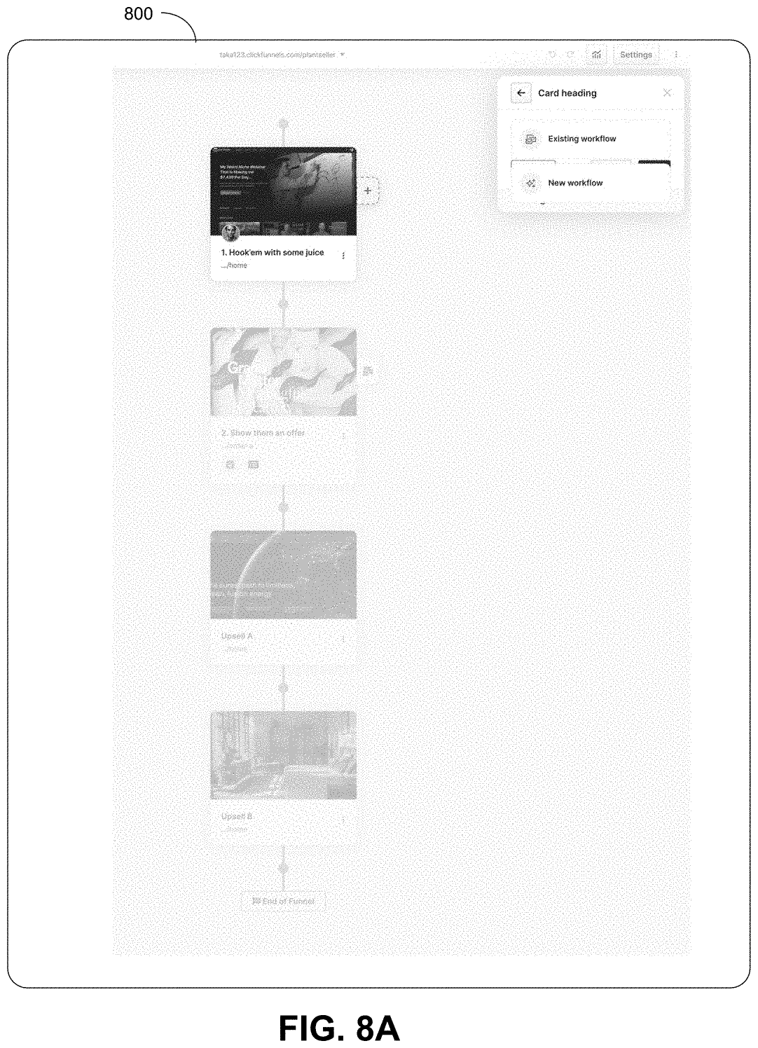

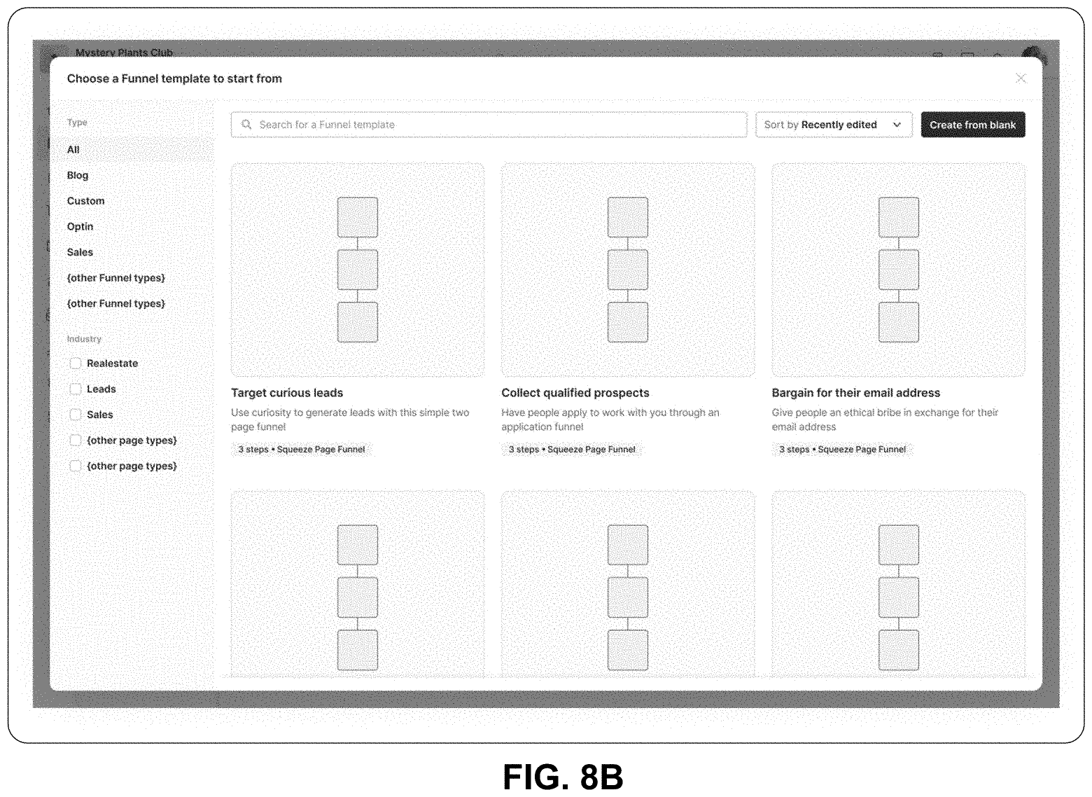

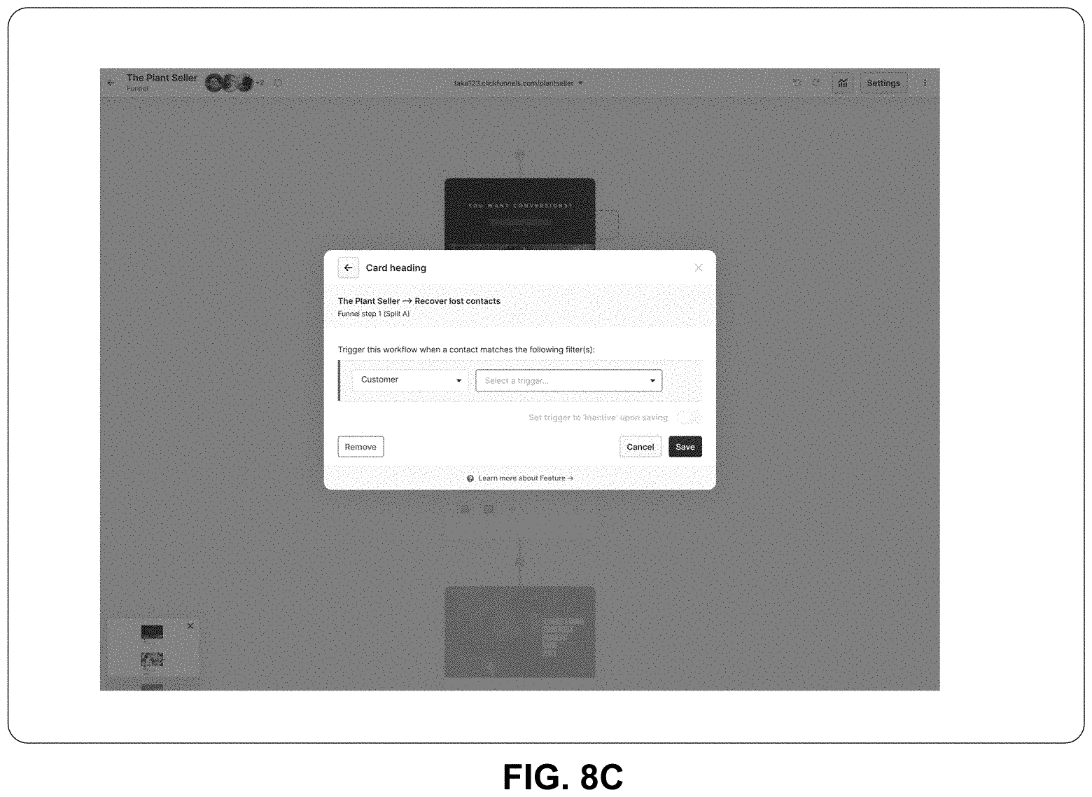

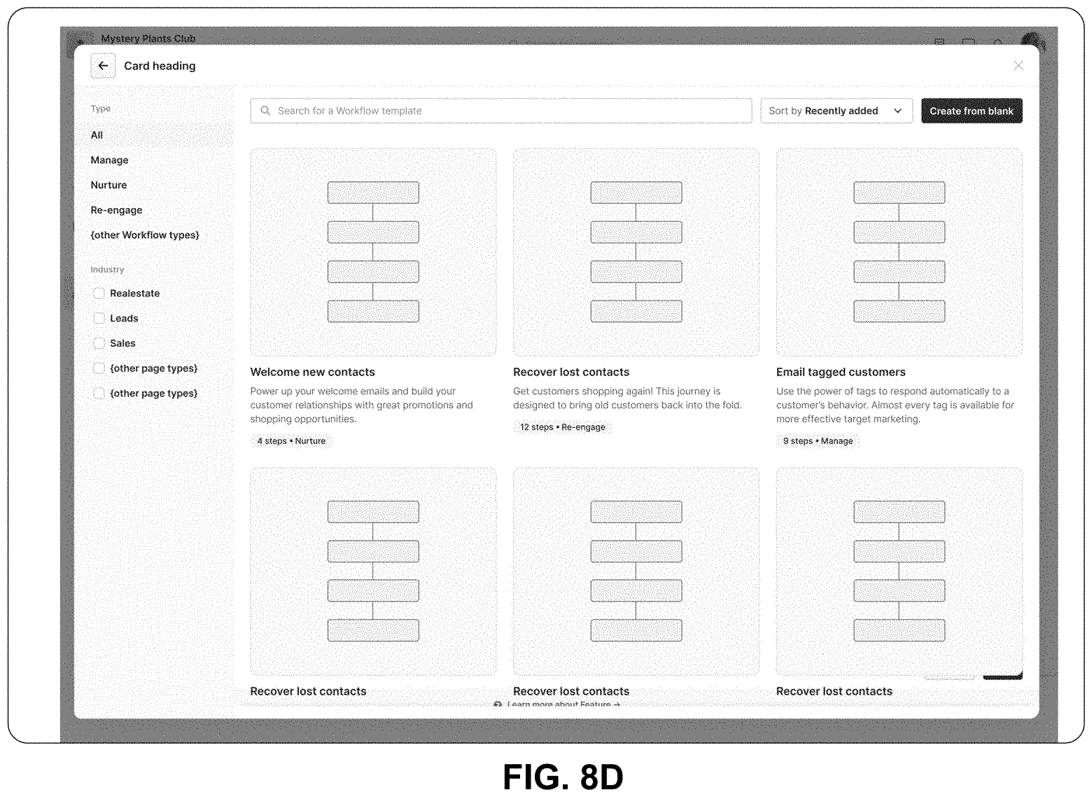

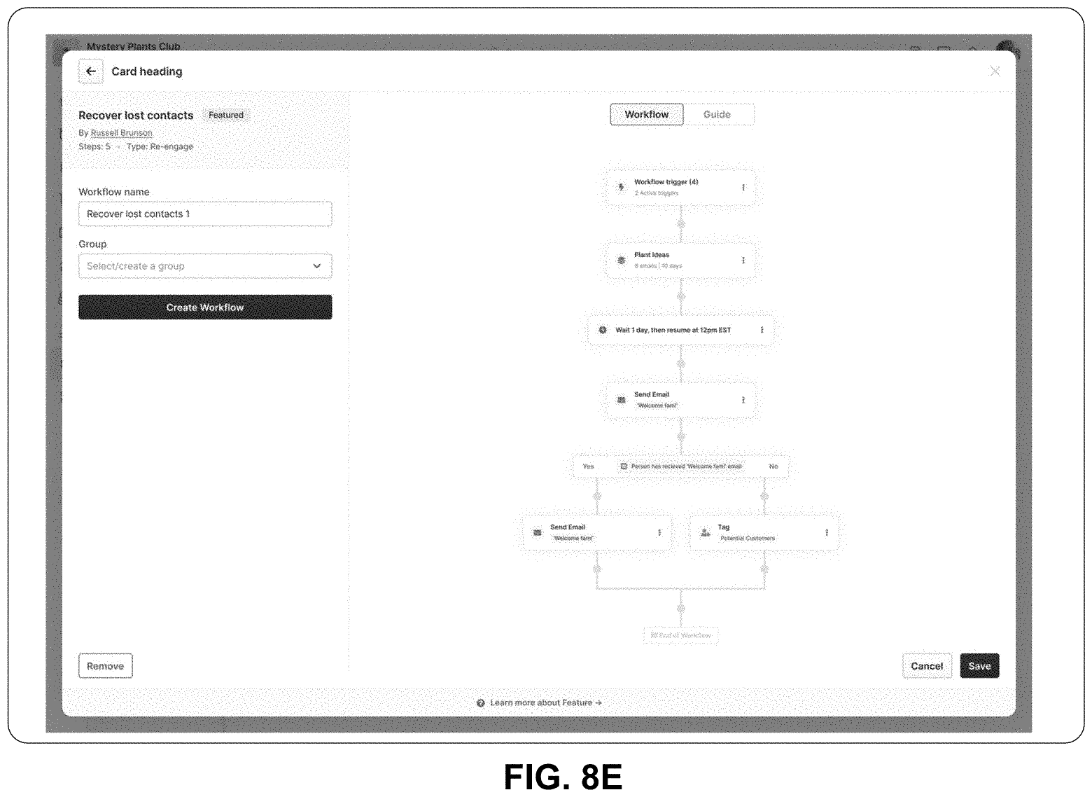

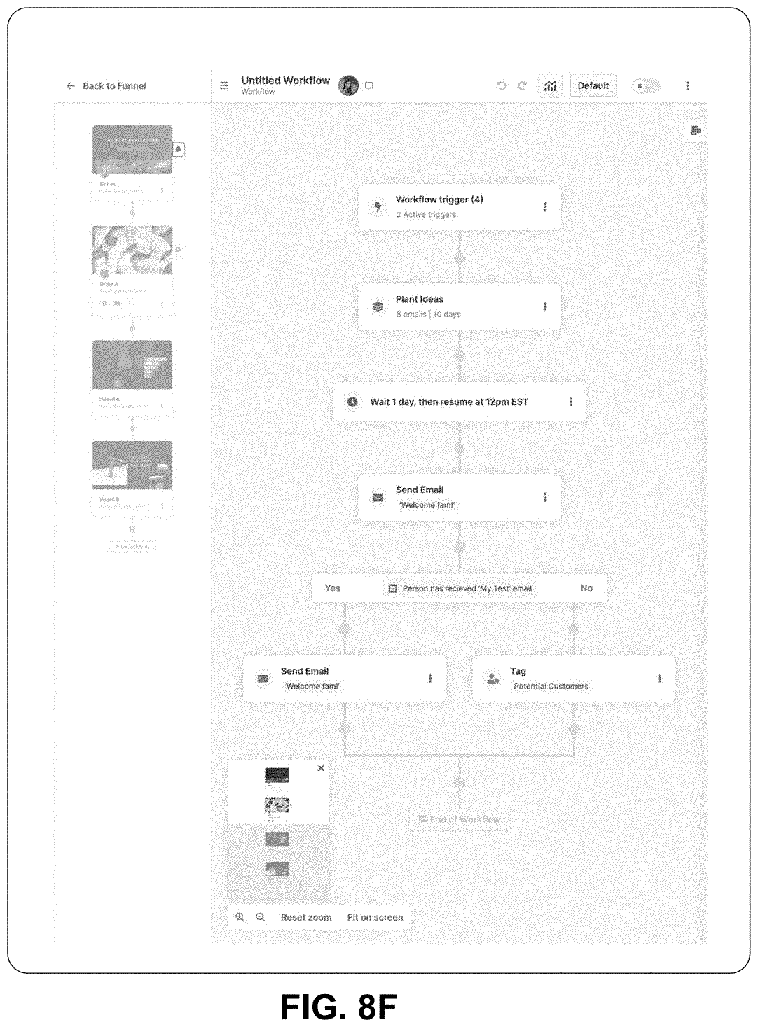

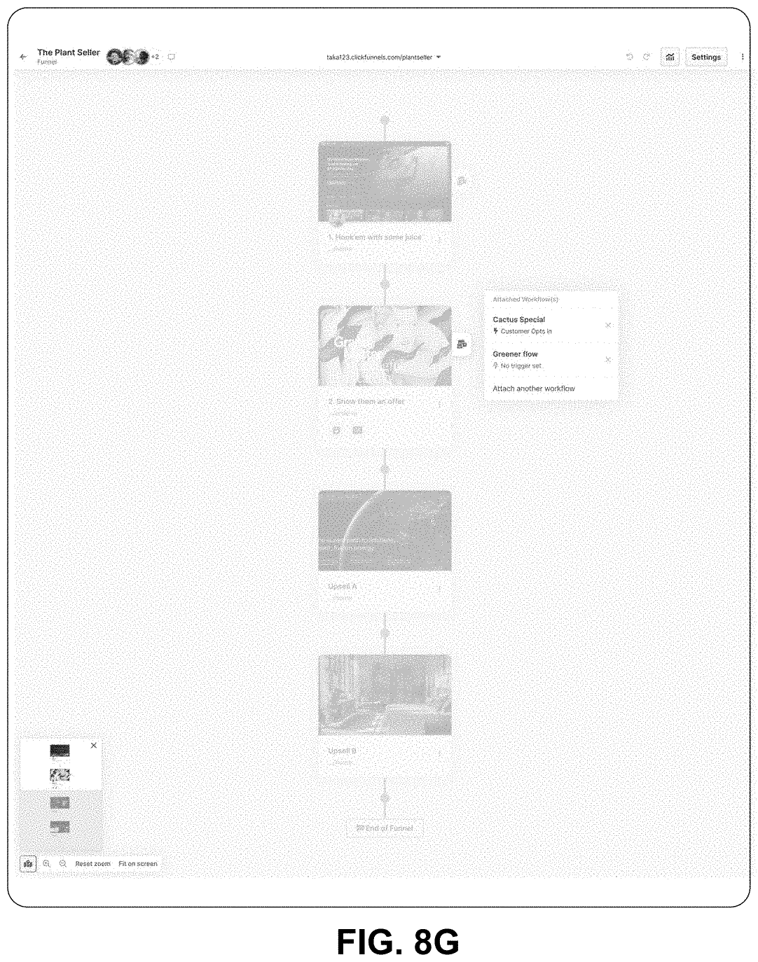

FIGS. 8A-8G illustrate a plurality of schematic representations of graphical user interfaces of the website creation and operation system for enabling a system administrator to create and edit workflows in accordance with one or more embodiments of the present disclosure.

FIG. 9 is a block diagram of an exemplary computing device 902 that may be utilized as a client device (e.g., client device 104) and/or a website creation and operation system 112 that may be configured to perform one or more of the processes described above. One will appreciate that one or more computing devices may implement the computing device 902. The computing device 902 may include a processor 904, a memory 906, a storage device 908, an I/O interface 910, and a communication interface 912, which may be communicatively coupled by way of communication infrastructure 914. While an exemplary computing device is shown in FIG. 9, the components illustrated in FIG. 9 are not intended to be limiting. Additional or alternative components may be used in other embodiments. Furthermore, in certain embodiments, the computing device 902 may include fewer components than those shown in FIG. 9. Components of the computing device 902 shown in FIG. 9 will now be described in additional detail.

In one or more embodiments, the processor 904 includes hardware for executing instructions, such as those making up a computer program. As an example and not by way of limitation, to execute instructions, the processor 904 may retrieve (or fetch) the instructions from an internal register, an internal cache, the memory 906, or the storage device 908 and decode and execute them. In one or more embodiments, the processor 904 may include one or more internal caches for data, instructions, or addresses. As an example and not by way of limitation, the processor 904 may include one or more instruction caches, one or more data caches, and one or more translational lookaside buffers (TLBs). Instructions in the instruction caches may be copies of instructions in the memory 906 or the storage device 908.

The computing device 902 includes memory 906, which is coupled to the processor(s) 904. The memory 906 may be used for storing data, metadata, and programs for execution by the processor(s). The memory 906 may include one or more of volatile and non-volatile memories, such as Random-Access Memory (“RAM”), Read Only Memory (“ROM”), a solid state disk (“SSD”), Flash, Phase Change Memory (“PCM”), or other types of data storage. The memory 906 may be internal or distributed memory.

The computing device 902 includes a storage device 908 that includes storage for storing data or instructions. As an example, and not by way of limitation, storage device 908 may include a non-transitory storage medium described above. The storage device 908 may include a hard disk drive (HDD), a floppy disk drive, Flash memory, an optical disc, a magneto-optical disc, magnetic tape, or a Universal Serial Bus (USB) drive or a combination of two or more of these. The storage device 908 may include removable or non-removable (or fixed) media, where appropriate. The storage device 908 may be internal or external to the computing device 600. In one or more embodiments, the storage device 908 is non-volatile, solid-state memory. In other embodiments, the storage device 908 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or Flash memory or a combination of two or more of these.

The computing device 902 also includes one or more input or output (“I/O”) devices/interfaces 910, which are provided to allow a user to provide input to, receive output from, and otherwise transfer data to and receive data from computing device 902. The I/O devices/interfaces 910 may include a mouse, a keypad or a keyboard, a touch screen, a camera, an optical scanner, network interface, modem, other known I/O devices or a combination of such I/O device/interfaces. The touch screen may be activated with a stylus or a finger.

The I/O devices/interfaces 910 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 910 is configured to provide graphical data to a display for presentation to a user. The graphical data may be representative of one or more graphical user interfaces and/or any other graphical content as may serve a particular implementation.

The computing device 902 can further include a communication interface 912. The communication interface 912 can include hardware, software, or both. The communication interface 912 can provide one or more interfaces for communication (such as, for example, packet-based communication) between the computing device 902 and one or more other computing devices or networks. As an example, and not by way of limitation, the communication interface 912 may include a network interface controller (NIC) or network adapter for communicating with an Ethernet or other wire-based network or a wireless NIC (WNIC) or wireless adapter for communicating with a wireless network, such as a Wi-Fi.

Additionally or alternatively, the communication interface 912 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 912 may facilitate communications with a wireless PAN (WPAN) (such as, for example, a BLUETOOTH®WPAN), a WI-FI network, a WI-MAX network, a cellular telephone network (such as, for example, a Global System for Mobile Communications (GSM) network), or other suitable wireless network or a combination thereof.

Additionally, the communication interface 912 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 914 may include hardware, software, or both that couples components of the computing device 902 to each other. As an example and not by way of limitation, the communication infrastructure 914 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

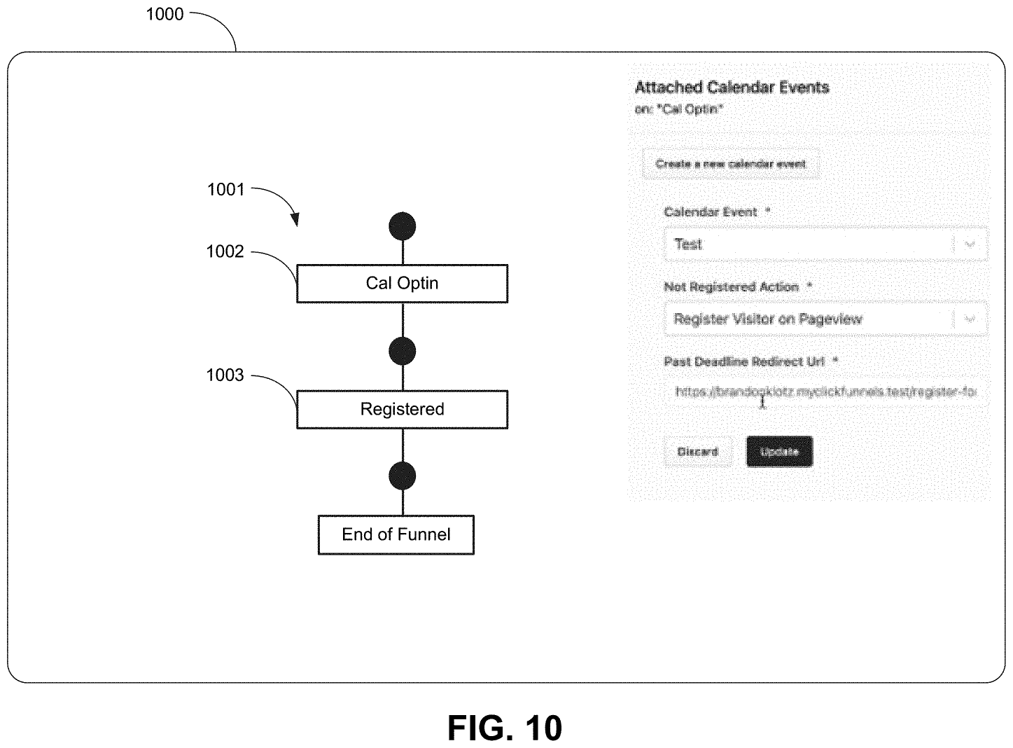

FIG. 10 depicts a Calendar Events GUI 1000 according to an exemplary embodiment of the present disclosure. A user creating a funnel 1001 may insert a “Cal Optin” option 1002 that allows them to create a new calendar event. Calendar events are time-based events that allow the funnel builder to allow or restrict access to pages based on certain predefined conditions. Calendar events may be used, for example, for users who have registered to attend a webinar or other such event, as shown in option 1003.

Within the funnel builder, the user can attach the calendar events and then customize the events. Based on what condition is desired, the user can set the calendar event to register the contact when they visit a certain page, for example. Depending on whether the event time has passed a predetermined deadline, the Calendar Event will evaluate whether an end user needs to be told that the event has already passed, or provide information regarding the next event, or some other information desired to be communicated to the end user based upon the timing of the calendar event.

The foregoing specification is described with reference to specific example embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

The embodiments of the disclosure described above and illustrated in the accompanying drawing figures do not limit the scope of the disclosure, since these embodiments are merely examples of embodiments of the disclosure, which is defined by the appended claims and their legal equivalents. Any equivalent embodiments are intended to be within the scope of this disclosure. Indeed, various modifications of the present disclosure, in addition to those shown and described herein, such as alternative useful combinations of the content features described, may become apparent to those skilled in the art from the description. Such modifications and embodiments are also intended to fall within the scope of the appended claims and legal equivalents.

What is claimed is:

1. A method comprising:
receiving a selection to create a website comprising a series of directional webpages configured to cause an end user interaction with a web site;
wherein the series of directional webpages comprises a tree of webpages configured to be provided to an end user of the website;
wherein the tree comprises at least two branches including possible paths to be provided to the end user during interaction with the website;
receiving a selection to create a conditional split in the tree of webpages, wherein one of the at least two branches is to be provided to the end user upon satisfaction of a predetermined condition associated with the conditional split;
wherein the predetermined condition is to be satisfied by the end user of the website via interaction with the website or by data associated with the end user;
analyzing interactions of the end user with the website or analyzing the data associated with the end user to determine whether the predetermined condition has been satisfied by the end user; and
responsive to determining that the predetermined condition has been satisfied, providing a webpage of one of the at least two branches to the end user.

2. The method of claim 1, wherein the at least two branches converge at a subsequent point in the tree to become a single branch.

3. The method of claim 1, further comprising generating and launching the website to include the series of directional webpages and the conditional split.

4. The method of claim 1, wherein the predetermined condition comprises a percentage of end users to have one of the at least two branches provided and another percentage of end users to have a second branch of the at least two branches.

5. The method of claim 1, wherein the webpage of one of the at least two branches includes one of a full screen content window, a single element of a full screen content window, or a pop-up content window.

6. A method comprising:
receiving a selection to create a website comprising a series of directional webpages configured to cause an end user interaction with a web site;
wherein the series of directional webpages comprises a tree of webpages configured to be provided to an end user of the web site, the tree comprising at least two branches including possible paths to be provided to the end user during interaction with the website;
splitting traffic between the at least two branches to provide a webpage of one of the at least two branches to the end user.

7. The method of claim 6 wherein the step of splitting traffic between the at least two branches to provide a webpage of one of the at least two branches to the end user comprises splitting traffic based upon random distribution.

8. The method of claim 6 wherein the step of splitting traffic between the at least two branches to provide a webpage of one of the at least two branches to the end user comprises setting up a custom traffic ratio.

9. The method of claim 8 wherein the step of setting up a custom traffic ratio comprises displaying, to the user, a slider that the user slides to set a desired ratio of traffic between two traffic paths.

10. The method of claim 6 wherein the step of splitting traffic between the at least two branches to provide a webpage of one of the at least two branches to the end user comprises creating a conditional split in the tree of webpages wherein one of the at least two branches is to be provided to the end user upon satisfaction of a predetermined condition associated with the conditional split and wherein the predetermined condition is to be satisfied by the end user of the website via interaction with the website or by data associated with the end user.

11. The method of claim 10 further comprising analyzing interactions of the end user with the website or analyzing the data associated with the end user to determine whether the predetermined condition has been satisfied by the end user.

12. The method of claim 10, wherein the predetermined condition comprises whether an end user has made a purchase from a user's website.

13. The method of claim 10, wherein the predetermined condition comprises whether an end user has interacted with a communication broadcast from a user.

14. The method of claim 10, wherein the predetermined condition comprises whether an end user has a predetermined number of followers in the end user's social media network.

15. A method comprising:
displaying, at a client device, a webpage of a series of directional webpages configured to cause an end user interaction within a website, the series of directional webpages comprising a tree of webpages comprising at least two branches including possible paths to be provided to the end user during interaction with the website;
detecting an end user interaction with the webpage of the series of directional webpages;
providing data regarding the detected end user interaction to a website operation system;
receiving, for display on the client device, instructions to display a second webpage of the series of directional webpages responsive to the end user interaction, the second webpage being from a branch of the at least two branches of the tree selected based at least partially on the detected user interaction; and
displaying the second webpage of the series of directional webpages.

16. The method of claim 15, wherein the webpage of the series of directional webpages and the second webpage of the series of directional webpages comprise a full screen content window, a partial screen content window, or a pop-up content window.
